(19) United States
(12) Patent Application Publication
(10) Pub. No.: US 2011/0291458 A1
(43) Pub. Date: Dec. 1, 2011

(54) Systems and Methods for Releasing Children from Safety Seats

(76) Inventors: Michael M. Blackmon, Rome, GA (US); Daniel T. Daly, Tuscaloosa, AL (US); Ryan D. Nelms, Marysville, OH (US); Joseph Ralph McGinty, Madison, AL (US); Stephen Michael Faes, Canisteo, NY (US)

(21) Appl. No.: 12/808,628

(22) PCT Filed: Jan. 14, 2009
(86) PCT No.: PCT/US09/31022

§ 371 Date: Aug. 18, 2011

Related U.S. Application Data
(60) Provisional application No. 61/011,024, filed on Jan. 14, 2008.

(51) Int. Cl. B60R 22/10; B60N 2/26; A47D 15/00

(52) U.S. Cl. 297/468

(57) ABSTRACT

The present disclosure generally pertains to systems and methods for releasing children from child safety seats. A child safety seat is secured to a vehicle seat, and a child is secured to the child safety seat. A single release action enables the child to be removed from the child safety seat thereby facilitating removal of the child from the child safety seat and reducing the time required to remove the child from the child safety seat.

### CROSS REFERENCE TO RELATED APPLICATION

This application claims priority to U.S. Provisional Patent Application No. 61/011,024, entitled “Child Safety Seat with Emergency Harness Release,” and filed on Jan. 14, 2008, which is incorporated herein by reference.

### RELATED ART

Child safety seats are used to increase the safety of children riding in vehicles. In general, a child safety seat is placed on a vehicle seat, and seat belts are used to secure the child safety seat to the vehicle seat. Further, a harness system is employed to secure the child to the safety seat. In the event of a vehicle accident, the safety seat provides better restraint for small children relative to the vehicle's seat belts, which are typically designed for adult passengers. In addition, many child safety seats have a shell composed of padding and/or deformable material that provides protection to the child during a vehicle accident.

A typical harness system employed for many child safety seats comprises a 5 point belt system that has a pair of shoulder belts and a crotch belt. The crotch belt is coupled to a seat buckle, and each of the shoulder belts is coupled to a respective buckle tongue that can be buckled to the seat buckle to secure the child to the safety seat. The seat buckle has a release actuator that is used to release the buckle tongues from the seat buckle in order to enable removal of the child from the safety seat.

To help prevent the child from slipping or escaping between the shoulder belts and to provide better restraint, many safety seats are equipped with a belt retainer that couples one of the shoulder belts to the other thereby keeping a distance between the shoulder belts fixed. The belt retainer has a release actuator that enables the shoulder belts to be released from such coupling. For example, activation of the release actuator may release one of the shoulder belts from the belt retainer. In another example, activation of the release actuator separates two belt retainer portions such that the shoulder belts are no longer coupled to one another by the belt retainer.

For a child safety seat having a belt retainer, removal of a child from the safety seat typically requires two release actions. In particular, the release actuator for the seat buckle is activated to release the shoulder belts from the seat buckle, and the release actuator for the shoulder retainer is activated to release the shoulder belts from one another. Although the use of both the seat buckle and the belt retainer provides better restraint, it is somewhat inconvenient to have two release actions required to remove a child from the safety seat.

In addition, requiring two release actions to remove of a child from a safety seat can be particularly problematic in an emergency, such as following a vehicle accident. In such a situation, the time required to remove a child from the safety seat may be critical. Further, the person attempting to remove a child from the safety seat may panic thereby increasing the difficulty of performing both release actions. In some cases, the person attempting to remove a child from the safety seat is unfamiliar with the design of the safety seat, and requiring such person to locate and activate two release actuators makes removal of the child more difficult and time consuming.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a front view of an exemplary child safety seat secured to a vehicle seat.

FIG. 2 is a front view of the child safety seat shown by FIG. 1.

FIG. 3 is a back view of the base for the child safety seat shown by FIG. 1.

FIG. 4 depicts the base shown by FIG. 3 when an emergency release actuator of the child safety seat is in a pre-activation position.

FIG. 5 depicts the base shown by FIG. 3.

FIG. 6 is a front view depicting the base shown by FIG. 3 showing components normally hidden from view.

FIG. 7 is a back view of the child safety seat shown by FIG. 1 when the emergency release actuator is in an activated position such that shoulder belts are released from the anchors depicted by FIG. 6.

FIG. 8 depicts one of the anchors shown by FIG. 6 when the emergency release actuator has been moved to the activated position.

FIG. 9 is a front view of the base shown by FIG. 7 after the shoulder belts have been released from the anchors and loops at the ends of the shoulder belts have moved to the front of the child safety seat by passing through apertures in the base of the safety seat.

FIG. 10 is a front view of the child safety seat shown by FIG. 9.

FIG. 11 depicts an exemplary seat buckle and belt retainer of a child safety seat, such as is depicted in FIG. 1.

FIG. 12 depicts exemplary belt clips and buckle tongues of a child safety seat.

FIG. 13 depicts the embodiment of FIG. 11 with shoulder belts removed for illustrative purposes.

FIG. 14 depicts the embodiment of FIG. 13 after the belt retainer has been moved to a fully extended position.

FIG. 15 is a cross-sectional view of an exemplary arm cover depicted in FIG. 14.

FIG. 16 depicts an exemplary seat buckle, such as is depicted in FIG. 11, with a button and a cover removed to expose components normally hidden.

FIG. 17 depicts the seat buckle of FIG. 16.

FIG. 18 depicts the embodiment of FIG. 13 with an exemplary belt retainer cover and an exemplary arm cover removed for illustrative purposes.

FIG. 19 depicts the embodiment of FIG. 18 after the belt retainer has been moved to a fully extended position.

FIG. 20 depicts the embodiment of FIG. 18 with an exemplary belt retainer plate removed for illustrative purposes.

FIG. 21 depicts the embodiment of FIG. 20 with springs removed for illustrative purposes.

FIG. 22 depicts the embodiment of FIG. 21 after an exemplary release actuator has been activated to release a pulley and a scissor arm.

FIG. 23 depicts the embodiment of FIG. 21 after the belt retainer has been moved to a fully extended position.

FIG. 24 depicts the embodiment of FIG. 21 with an arm release element removed for illustrative purposes as an exemplary release actuator of the seat buckle is being activated to release the buckle tongues and the belt retainer.

FIG. 25 depicts the embodiment of FIG. 21 with the release actuator removed for illustrative purposes.

FIG. 26 depicts the embodiment of FIG. 25 with the pulley removed for illustrative purposes.

FIG. 27 depicts the embodiment of FIG. 26 with an exemplary belt retainer plate removed for illustrative purposes.

FIG. 28 depicts the embodiment of FIG. 27 with belt clips removed for illustrative purposes.

FIG. 29 is a front view of an exemplary belt clip.

FIG. 30 is a top view of the belt clip depicted by FIG. 29.

FIG. 31 is a side view of the belt clip depicted by FIG. 29.

FIG. 32 depicts the embodiment of FIG. 27 as the belt clips are being coupled to the belt retainer.

FIG. 33 depicts the embodiment of FIG. 27 as an exemplary release actuator of the seat buckle is being activated to release the buckle tongues and the belt retainer.

### DETAILED DESCRIPTION

The present disclosure generally pertains to systems and methods for releasing children from child safety seats. In one exemplary embodiment of the present disclosure, at least one belt of a child safety seat is secured to an anchor, such as a pin that passes through a loop of the belt. The anchor is coupled to an emergency release actuator that is accessible to a user when the child safety seat is secured to a vehicle seat. Activation of the emergency release actuator causes the anchor to release the belt that is secured to it thereby facilitating removal of the child from the safety seat. In fact, in at least one embodiment, activation of the emergency release actuator enables the child to be pulled from the safety seat without performing any other release actions. In one exemplary embodiment, both shoulder belts are released via activation of the emergency release actuator. However, it is possible for other numbers of shoulder belts and/or other types of belts to be released in other embodiments.

In another exemplary embodiment of the present disclosure, a child safety seat is equipped with both a seat buckle and a belt retainer for retaining the shoulder belts. Activation of a release actuator by a user releases at least one belt from the seat buckle and also releases the shoulder belts from each other such that the shoulder belts are no longer coupled to each other by the belt retainer. Thus, activation of the release actuator enables a child to be pulled from the safety seat without performing any other release actions.

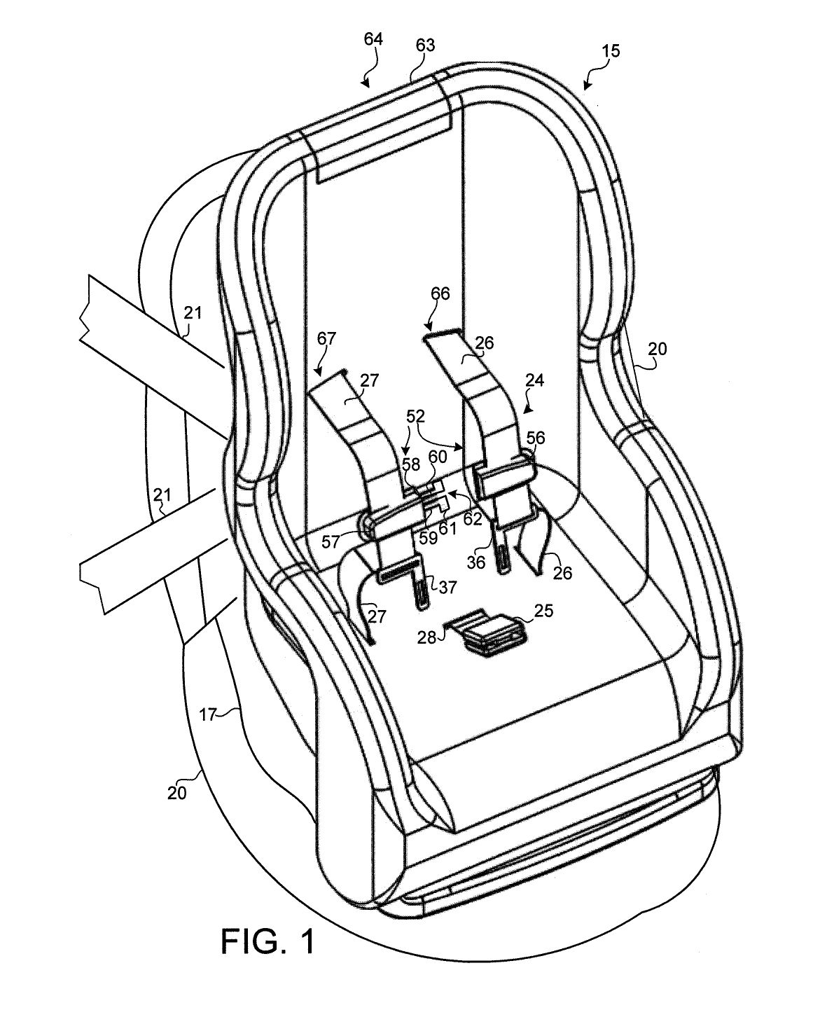

FIG. 1 depicts a child safety seat 15 of an exemplary embodiment of the present disclosure. The safety seat 15 has a base 17. The seat 15 may have a cover (not shown) with embedded cushions for the comfort and safety of a child secured to the safety seat 15. The safety seat 15 can be secured to a vehicle seat 20 by passing a seat belt 21 of the vehicle through the base 17 and securing the seat belt 21 to a seat buckle (not shown) of the vehicle. In other embodiments, the safety seat 15 can be secured to a vehicle via other techniques and configurations.

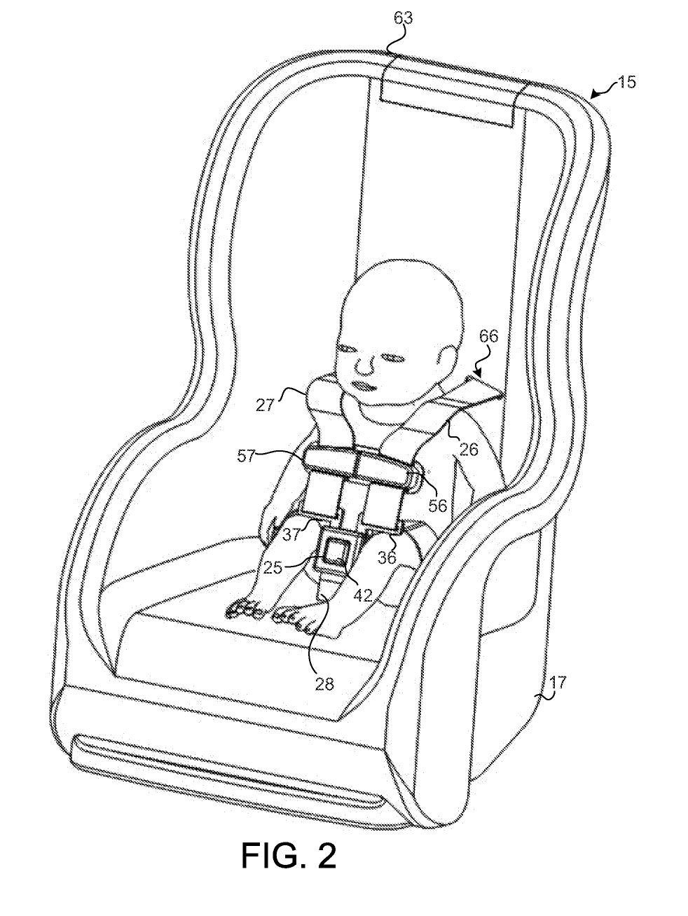

The safety seat 15 has a harness system 24 for securing a child to the safety seat 15. In the exemplary embodiment shown by FIG. 1, the harness system 24 comprises a five point belt system. In this regard, the harness system 24 has a seat buckle 25, a pair of shoulder belts 26, 27, and a crotch belt 28. The system 24 is a “five point” belt system in the sense that the belts 26-28 are secured to the base 17 at five points. In particular, an end of the crotch belt 28 is secured to the base 17, and both ends of each shoulder belt 26, 27 are secured to the base 17. The harness system 24 shown by FIGS. 1 and 2 is exemplary, and other types of harness systems can be used in other embodiments. In addition, various techniques may be used to secure the belts 26-28 to the base 17. In one exemplary embodiment, each end of each belt 26-28 forms a loop and is secured to the base 17 by passing a component of the base 17 through the loop.

As shown by FIGS. 1 and 2, the seat buckle 25 is coupled to the crotch belt 28, and the shoulder belts 26, 27 are coupled to buckle tongues 36, 37, respectively. In one exemplary embodiment, a portion of the seat buckle 25 passes through a loop formed by an end of the crotch belt 28. Each of the buckle tongues 36, 37 can be buckled or otherwise detachably coupled to the seat buckle 25 in order to secure a child to the safety seat 15, as shown by FIG. 2.

The seat buckle 25 has a release actuator 41 (FIG. 2) that can be activated in order to release the buckle tongues 36, 37 from the seat buckle 25. In the embodiment shown by FIG. 1, the release actuator 41 comprises a button 42, which is depressed in order release the buckle tongues 36, 37 from the seat buckle 25. In other embodiments, other types of release actuators can be used.

The safety seat 15 also has a belt retainer 52. As shown by FIG. 2, the belt retainer 52 is coupled to and retains both shoulder belts 26, 27 helping to prevent the child from slipping or otherwise escaping between the shoulder belts 26, 27. Various configurations of the belt retainer 52 are possible. In the embodiment depicted by FIG. 2, the belt retainer 52 has two interconnected portions: a female portion 56 and a male portion 57. The shoulder belt 26 is coupled to (e.g., passes through) one retainer portion 56, and the shoulder belt 27 is coupled to (e.g., passes through) the other retainer portion 57. The male portion 57 has a pair of tongs 58, 59 (FIG. 1) that can be inserted into the female portion 56 in order to secure the two portions 56, 57 to one another. The retainer 52 has at least one release actuator 62 that, when activated, separates the retainer portions 56, 57, as shown by FIG. 1.

In the exemplary embodiment shown by FIGS. 1 and 2, the release actuator 62 of the retainer 52 comprises a pair of tabs 60, 61 formed on tongs 58, 59, respectively. When the retainer portions 56, 57 are interconnected, as shown by FIG. 2, the tabs 60, 61 are exposed and prevent the portions 60, 61 from being separated. To remove a child from the safety seat 15, a user depresses the tabs 60, 61 and slides the tongs 58, 59 of the male portion 57 out of the female portion 56 thereby separating the portions 56, 57, as shown by FIG. 1. Thus, when interconnected, the retainer portions 56, 57 can help to secure a child to the safety seat 15, but the portions 56, 57 can be separated to enable removal of the child from the safety seat 15. In other embodiments, other configurations of the belt retainer 52 are possible. For example, it is possible to configure the retainer 52 such that one of the shoulder belts 26, 27 is released from the retainer 52 in order to enable a child to be removed from the safety seat 15. Yet other embodiments of the retainer 52 are possible.

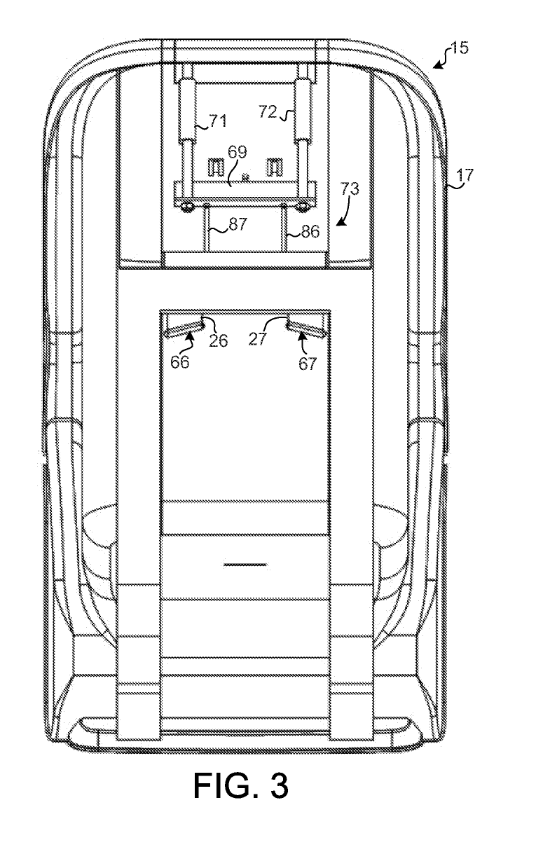

As described above, one end of the crotch belt 28 is coupled to the seat buckle 25, and the other end of the crotch belt 28 is secured to the base 17 of the safety seat 15. Further, the ends of the shoulder belts 26, 27 are secured to the base 17 of the safety seat 15. In this regard, each of the shoulder belts 26, 27 passes through a respective aperture 66, 67 (FIG. 3) in the base 17 of the safety seat 15, and each of the shoulder belts 26, 27 is anchored to a back of the base 17. In one exemplary embodiment, as will be described in more detail hereafter, the belts 26, 27 can be released from the back of the base 17 to enable the child to be removed from the safety seat 15.

To secure a child in the safety seat 15, a user places a child on the base 17 such that the child is supported by the base 17, and the user buckles each of the buckle tongues 36, 37 to the seat buckle 25, as shown by FIG. 2. The user also interconnects the retainer portions 56, 57 such that the shoulder belts 26, 27 are coupled to one another via the belt retainer 52, as shown by FIG. 2. To remove a child from the safety seat 15, a user may activate (e.g., depress) the button 42, thereby releasing the buckle tongues 36, 37 from the seat buckle 25, and separate the retainer portions 56, 57, thereby releasing the shoulder belts 26, 27 from each other. The user may then pull the child from the safety seat 15 such that the child passes between the shoulder belts 26, 27.

The safety seat 15 preferably has an emergency release actuator 64 (FIG. 1) that can be used to release a child from the safety seat 15 in an emergency. In one exemplary embodiment, the emergency release actuator 64 comprises a handle 63, referred to hereafter as an “emergency release handle,” that can be pulled or otherwise activated by a user during an emergency in order to enable a child to be removed from the safety seat 15 without performing another release action, such as activating the button 42 or separating the retainer portions 56, 57. Activation of the emergency release handle 63 releases at least one of the shoulder belts 26, 27 from the back of the base 17 thereby enabling the child to be pulled from the safety seat 15 even while the buckle tongues 36, 37 are buckled to the seat buckle 25 and/or while the shoulder belts 26, 27 are coupled to one another via the retainer 52. In one exemplary embodiment, activation of the release handle 63 releases both of the shoulder belts 26, 27 from the back of the safety seat base 17, as will be described in more detail hereafter.

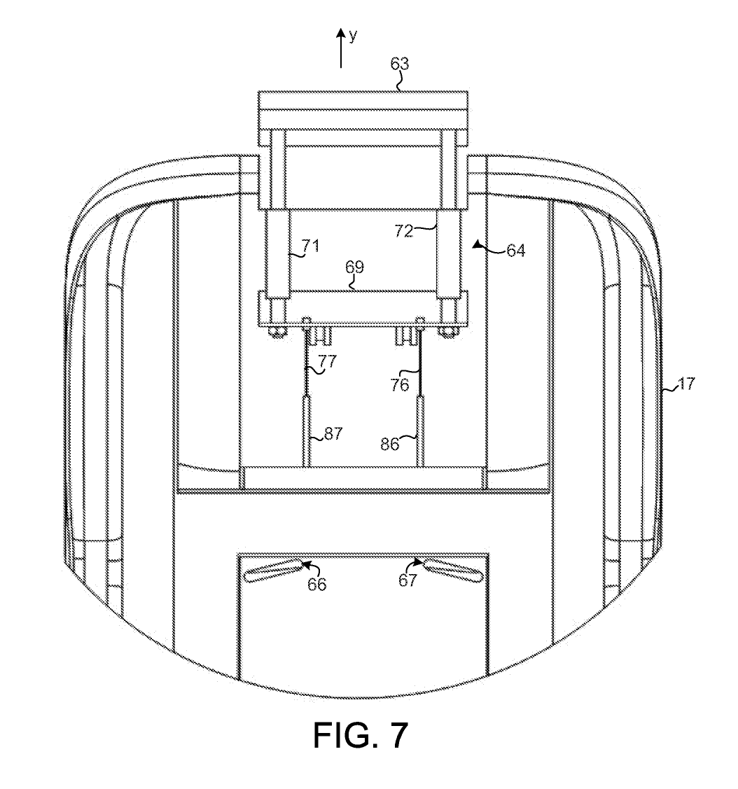

FIG. 3 depicts the back of the safety seat base 17. As shown by FIG. 3, the emergency release actuator 64 comprises a bar 69 and a pair of rods 71, 72 in addition to the emergency release handle 63. The emergency release handle 63 is coupled to the bar 69 by the pair of rods 71, 72. Further, the bar 69 is coupled to a cable release system 73, as will be described in more detail hereafter. In this regard, the cable release system 73 has a cable 76 (FIG. 7) that is coupled to an anchor (not shown in FIG. 3) for the belt 26, and the cable release system 73 has a cable 77 (FIG. 7) that is coupled to an anchor (not shown in FIG. 3) for the belt 27. In one exemplary embodiment, each cable 76, 77 is composed of steel, but other materials are possible in other embodiments.

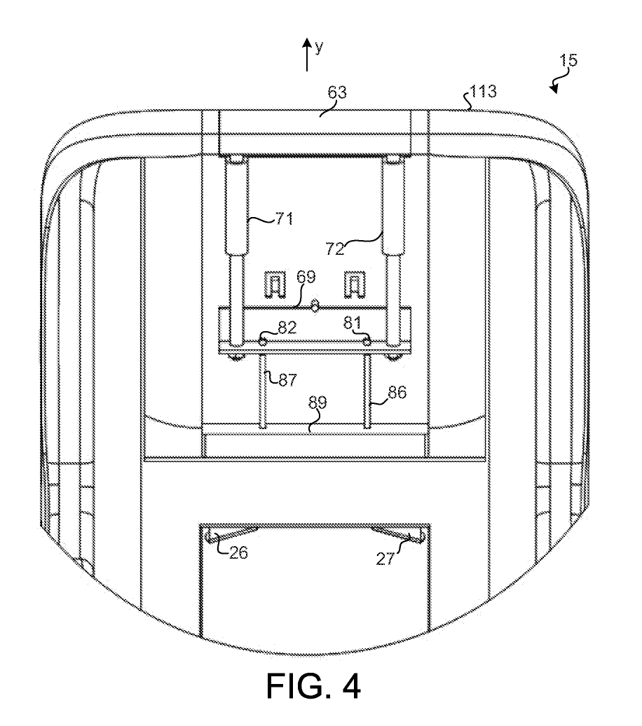

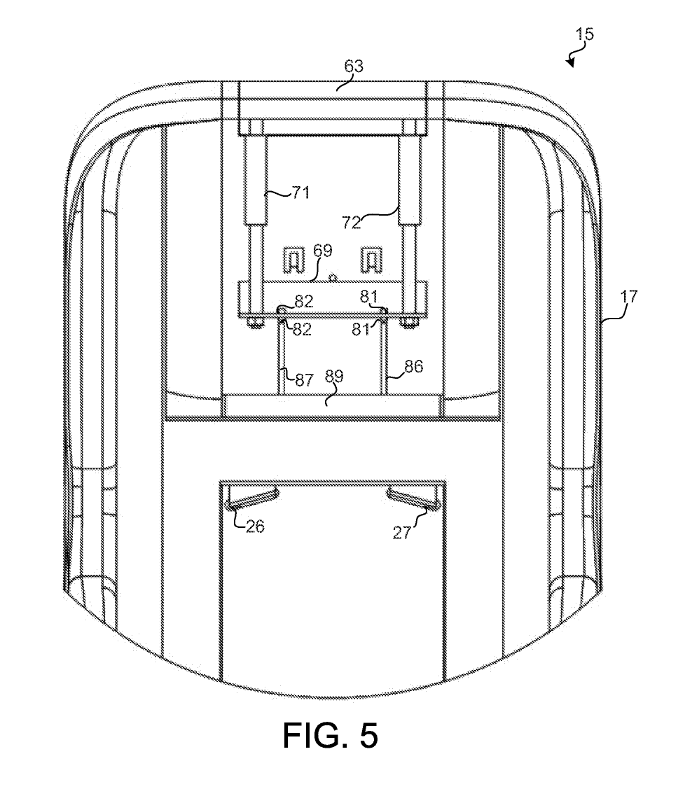

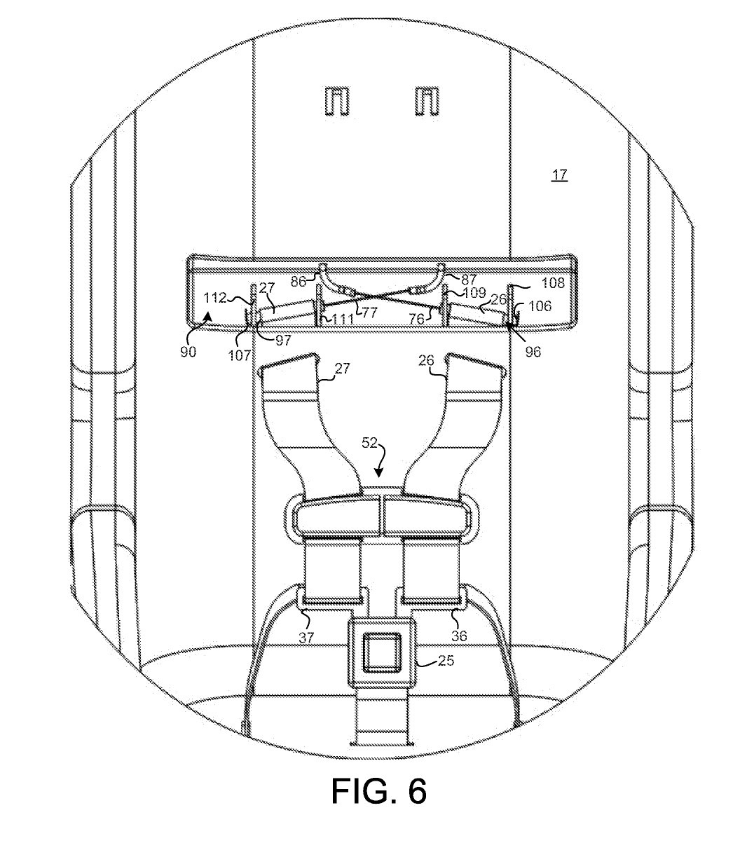

Referring to FIGS. 4 and 5, the cable 76 passes through a pair of cable retainers 81, one on each side of the bar 69. The cable retainers 81 secure the cable 76 to the bar 69. The cable 77 passes through a pair of cable retainers 82, one on each side of the bar 69. The cable retainers 81 secure the cable 77 to the bar 69. Further, the cable release system 73 has a pair of sleeves 86, 87. The cable 76 passes through and is guided by the sleeve 86, and the cable 77 passes through and is guided by the sleeve 87. In one exemplary embodiment, each sleeve 86, 87 is a spring that is composed of steel. However, in other embodiments, the sleeves 86, 87 can have other configurations and/or be composed of other materials. As shown by FIG. 5, each sleeve 86, 87 passes a cover 89 that holds the sleeves 86, 87. The cover 89 houses a chamber 90 (FIG. 6) in which various components, such as anchors, are positioned and hidden from view.

FIG. 6 depicts a front view of the base 17 shown by FIGS. 4 and 5. A front portion of the base 17 is cut away for illustrative purposes to expose components within the chamber 90. Such components are normally hidden from view.

The sleeves 86, 87, as well as the cables 76, 77 within the sleeves 86, 87, have sufficient flexibility to allow such components to be bent during installation thereby facilitating installation and accommodating various child safety seat designs. Once installed, the sleeves 86, 87 generally remain stationary relative to the base 17.

Referring to FIG. 6, the end of shoulder belt 26 forms a loop 96, and the end of the shoulder belt 27 forms a loop 97. Further, an anchor 106 passes through the loop 96 thereby securing the shoulder belt 26 to the base 17 of the safety seat 15, and an anchor 107 passes through the loop 97 thereby securing the shoulder belt 27 to the base 17 of the safety seat 15. In one exemplary embodiment, each anchor 106, 107 comprises a steel cylindrical pin. In other embodiments, other configurations and materials for the anchors 106, 107 are possible.

The anchor 106 passes through holding members 108, 109 that hold the anchor 106, and the anchor 107 passes through holding members 111, 112 that hold the anchor 107. Further, the anchor 106 is inserted through a hole in the holding member 109, and such hole passes completely through the holding member 109. Thus, the anchor 106 may be positioned as shown in FIG. 6 by inserting the anchor 106 through the hole in the holding member 109 until the anchor 106 contacts the holding member 108. In one exemplary embodiment, the anchor 106 is inserted through a hole in the holding member 108, but such hole does not pass completely through the holding member 108. The holding member 108 serves as a stop for the anchor 106 and will be referred to hereafter as a “stop.”

In addition, the anchor 106 is coupled to the cable 76, and the cable 76 is sufficiently stiff to push the anchor 106 against the stop 108 in order to ensure that the anchor 106 does not move until the emergency release handle 63 is activated, as will be described in more detail hereafter. The position of the handle 63 shown in FIG. 4 shall be referred to hereafter as the “pre-activation position.” In such a position, the handle 63 is flush with a rim 113 of the base 17 in the exemplary embodiment shown by FIG. 3. In other embodiments, other types of actuators may be used, and other positions of the handle 63 or other actuators are possible.

Referring to FIG. 6, the anchor 107 is inserted through a hole in the holding member 111, and such hole passes completely through the holding member 111. Thus, the anchor 107 may be positioned as shown in FIG. 6 by inserting the anchor 107 through the hole in the holding member 111 until the anchor 107 contacts the holding member 112. In one exemplary embodiment, the anchor 107 is inserted through a hole in the holding member 112, but such hole does not pass completely through the holding member 112. The holding member 112 serves as a stop for the anchor 107 and will be referred to hereafter as a “stop.” In addition, the anchor 107 is coupled to the cable 77, and the cable 77 is sufficiently stiff to push the anchor 107 against the stop 112 in order to ensure that the anchor 107 does not move until the emergency release handle 63 is activated, as will be described in more detail hereafter.

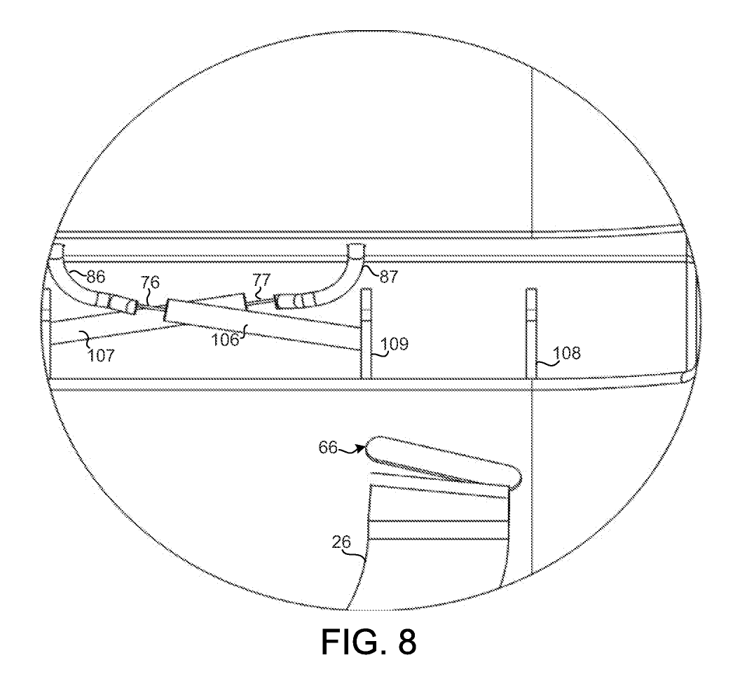

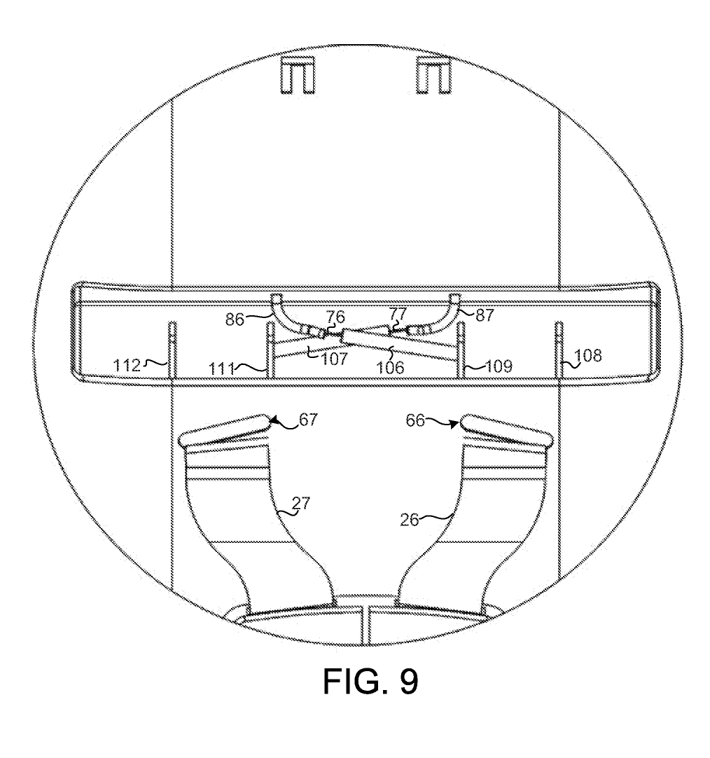

To release a child from the safety seat 15, a user can activate the handle 63 by pulling it from the pre-activated position shown by FIG. 4 to an “activated position” shown by FIG. 7. In the activated position, the handle 63 is no longer flush with the rim 113 of the base 17 but is instead higher (in the y-direction) than such rim 113. The movement of the handle 63 from the pre-activation position to the activated position pulls each cable 76, 77 thereby pulling each anchor 106, 107 from its respective belt loop 96, 97, as shown by FIGS. 8 and 9. When the anchor 76 is pulled from the belt loop 96, the shoulder belt 26 is no longer secured to the base 17, and when the anchor 77 is pulled from the belt loop 97, the shoulder belt 27 is no longer secured to the base 17. Note that FIG. 8 depicts the anchor 107 after it has been pulled from the loop 97. Therefore, activation of the emergency release handle 63 releases each shoulder belt 26, 27 from the base 17 of the safety seat 15 thereby enabling the child to be pulled from the safety seat 17 even if the buckle tongues 36, 37 are buckled to the seat buckle 25 and/or the shoulder belts 26, 27 are coupled to one another via the belt retainer 52.

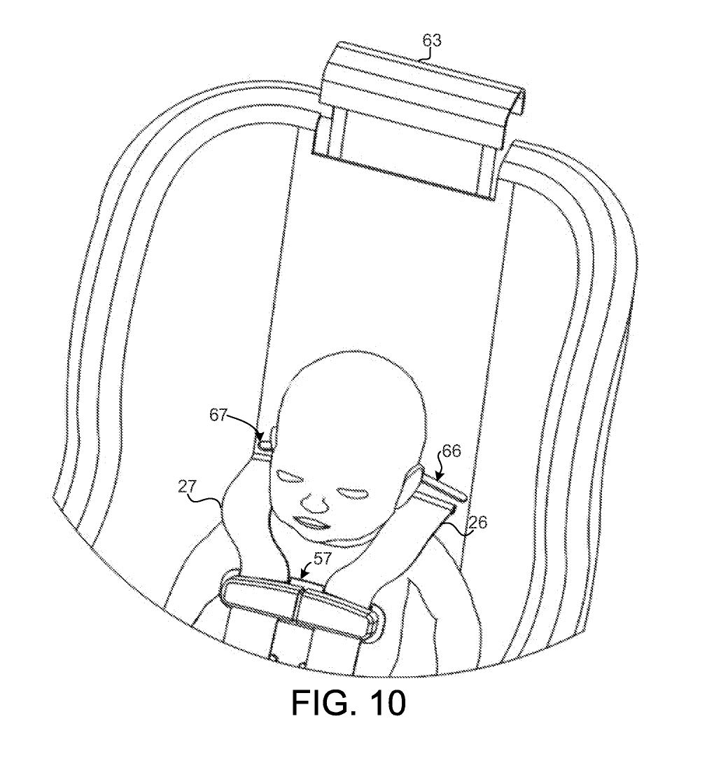

In this regard, once the emergency release handle 63 is activated, the belt 26 is allowed to slide through the aperture 66 until the loop 96 passes from the back of the safety seat base 17 to the front of the safety seat base 17. In addition, the belt 27 is allowed to slide through the aperture 67 until the loop 97 passes from the back of the safety seat base 17 to the front of the safety seat base 17. FIG. 9 shows the base 17 after the anchors 106, 107 have been pulled from the loops 96, 97 and after the loops 96, 97 have passed through the apertures 66, 67 to the front of the base, as shown in FIG. 10. Thus, as the child is lifted from the safety seat 15, the shoulder belts 26, 27 no longer secure the child to the seat 15 and fall away from the child. Accordingly, a single release action (e.g., activation of the emergency release actuator 64) enables a child previously secured to the safety seat 15 to be removed from such seat 15.

It should be noted that the embodiments described above are exemplary, and other configurations for enabling the shoulder belts 26, 27 to be released from the safety seat 15 are possible. For example, U.S. Pat. No. 7,448,690, which is incorporated herein by reference, describes exemplary techniques for releasing shoulder belts from a safety seat. In addition, it is possible to release the crotch belt 28 from the safety seat 15 using similar techniques as described above for the shoulder belts 26, 27. For example, a third cable (not shown) passing through a sleeve (not shown), similar to the cables 76, 77 and sleeves 86, 67, may be configured to pull an anchor (not shown) passing through a loop of the crotch belt 28 in order to release the crotch belt 28 from the safety seat 15. Various other modifications would be apparent to one of ordinary skill upon reading this disclosure.

Further, in some embodiments, a single release action releases the buckle tongues 36, 37 from the seat buckle 25 and also releases the belt retainer 52 such that it no longer couples one shoulder belt 26, 27 to the other. Thus, the shoulder belts 26, 27 are released from each other and also from the seat buckle 25 thereby enabling a child to be removed from the safety seat 15 without activating the emergency release actuator 64 and/or performing another release action.

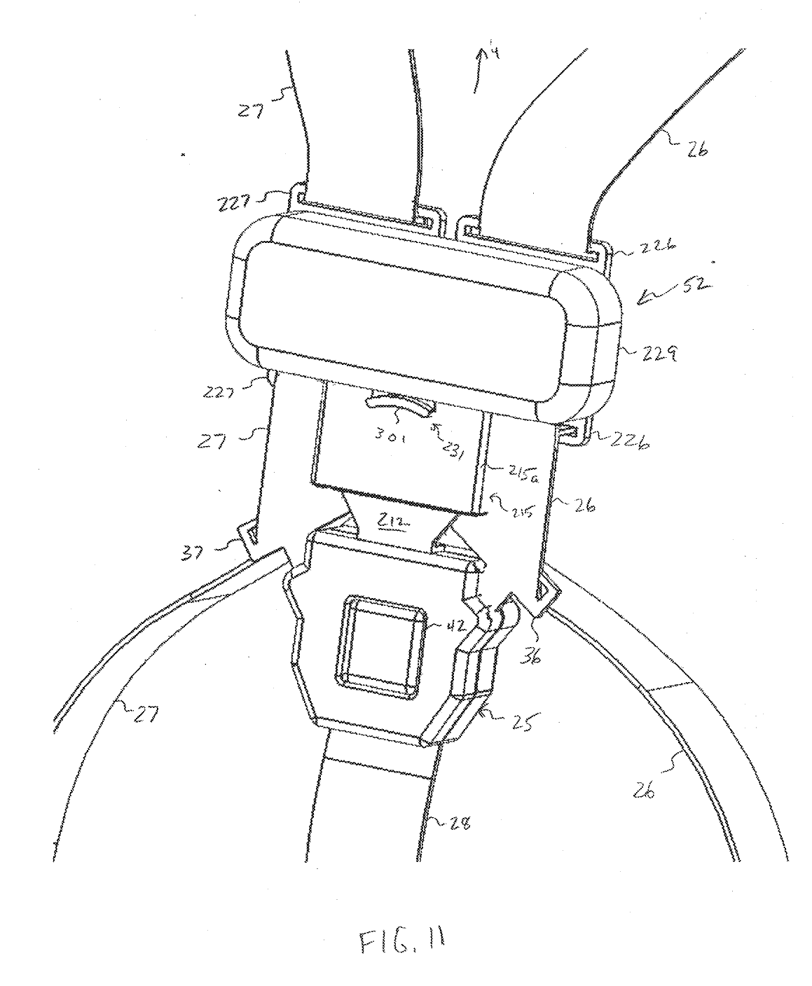

An exemplary embodiment that allows a single release action to release the buckle tongues 36, 37 and the belt retainer 52 is shown by FIG. 11. In the exemplary embodiment shown by FIG. 11, the seat buckle 25 has a base plate 212. The belt retainer 52 is coupled to the base plate 212 via a movable arm, which is hidden in FIG. 11 by an arm cover 215. Further, each of the shoulder belts 26, 27 passes through a respective belt clip 226, 227, and each belt clip 226, 227 is detachably coupled to the belt retainer 52, as will be described in more detail hereafter. A cover 229 hides components of the belt retainer 52, which will be described in more detail hereafter.

As shown by FIG. 11, the belt retainer 52 has a release actuator 231, which can be user-activated by pushing the release actuator 231 in the y-direction. The release actuator 231 is spring loaded such that it returns to its original position when released by the user. In other embodiments, other techniques for activating a release actuator 231 are possible. Use of the release actuator 231 will be described in more detail hereafter.

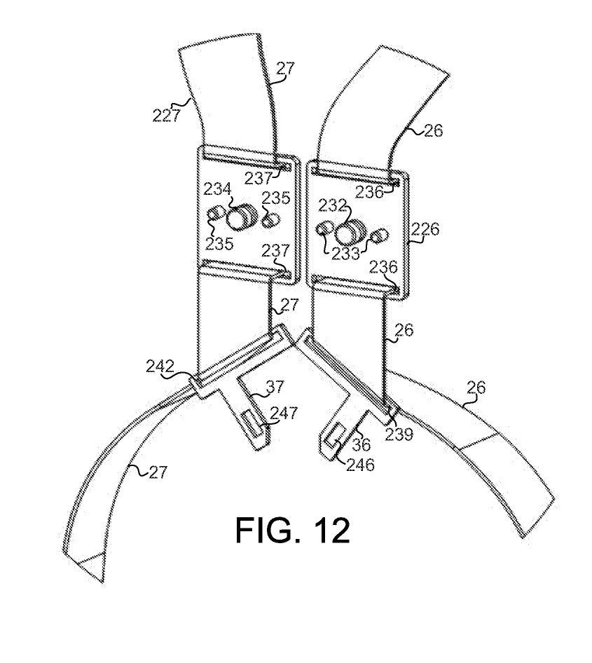

FIG. 12 shows the shoulder belts 26, 27 when the buckle tongues 36, 37 are not buckled to the seat buckle 25 and the belt clips 226, 227 are not coupled to the belt retainer 52. As shown by FIG. 12, the belt clip 226 has a peg 232 that is used to detachably couple the belt clip 226 to belt retainer 52, as will be described in more detail hereafter. The belt clip 226 also has a pair of alignment pins 233 that are used to help align the belt clip 226 with the belt retainer 52.

Similarly, the belt clip 227 has a peg 234 that is used to detachably couple the belt clip 227 to belt retainer 52, as will be described in more detail hereafter. The belt clip 227 also has a pair of alignment pins 235 that are used to help align the belt clip 227 with the belt retainer 52.

As shown by FIG. 12, the belt clip 226 has slots 236 through which the belt 26 passes to secure the belt clip 226 to the belt 26, and the belt clip 227 has slots 237 through which the belt 27 passes to secure the belt clip 227 to the belt 27. The buckle tongue 36 has a slot 239 through which the belt 26 passes, and the buckle tongue 37 has a slot 242 through which the belt 27 passes. A user can slide each buckle tongue 36, 37 along its respective belt 26, 27, and a user can slide each belt clip 226, 227 along its respective belt 26, 27. As shown by FIG. 12, the buckle tongues 36, 37 have holes 246, 247, respectively, which are used to couple the buckle tongues 36, 37 to the seat buckle 25, as will be described in more detail hereafter.

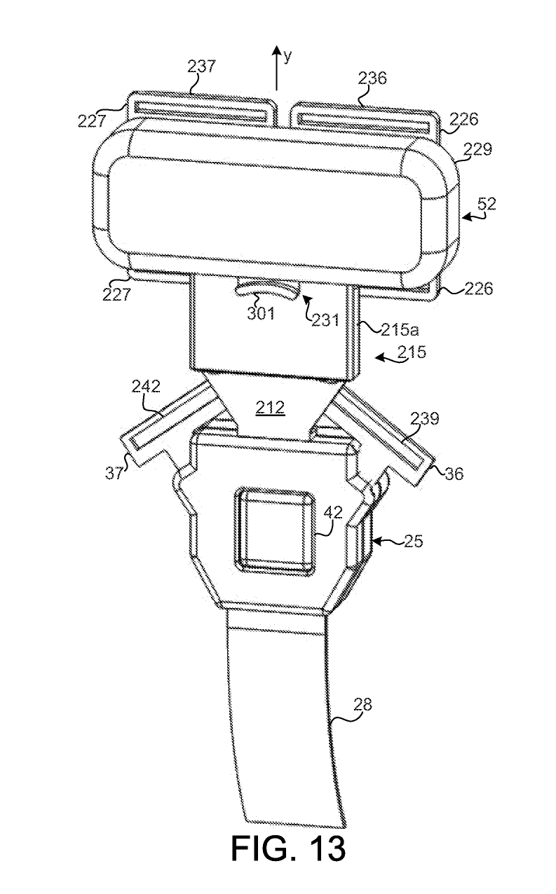

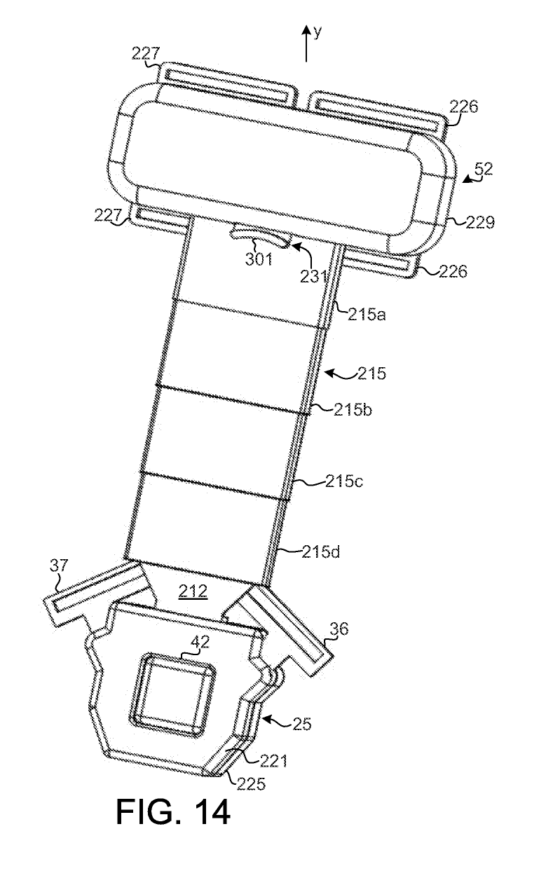

FIG. 13 depicts the seat buckle 25 and the belt retainer 52 of FIG. 11 with the shoulder belts 26, 27 removed for illustrative purposes. The arm cover 215 is extendable and collapsible so that the belt retainer 52 can be moved back and forth along the y-direction while coupled to the seat buckle 25. Accordingly, a user may position the belt retainer 25 as may be desired depending on the size of the child to be restrained in the safety seat 15. FIG. 13 shows the arm cover 215 in a collapsed state. FIG. 14 shows the arm cover 215 after it has been extended from the collapsed state of FIG. 13 in order to move the belt retainer 52 away from the seat belt 25.

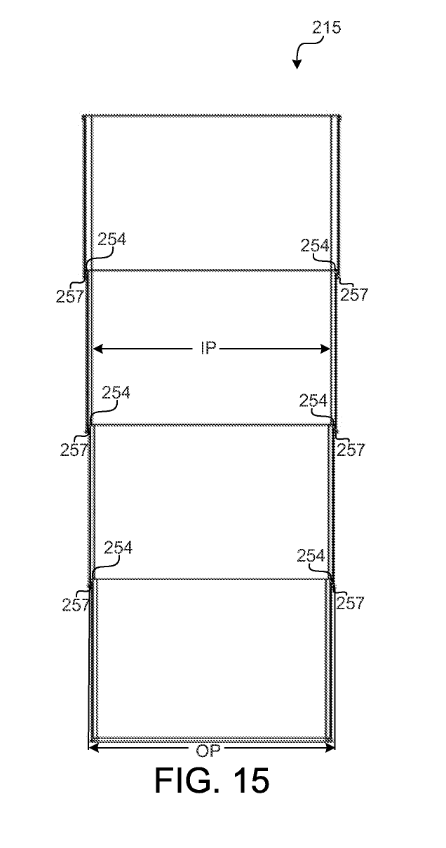

As shown by FIG. 14, the arm cover 215 comprises a plurality of sections 215a-215d. FIG. 15 shows a cross-sectional view of the arm cover 215 in a fully extended position. Each section 215a-d comprises an elongated, hollow tube 252. The tube 252 of each section 215a-215d has an outer perimeter that is smaller than an inner perimeter of an adjacent section 215a-215d in the y-direction. As an example, the outer perimeter (OP) of section 215c is smaller than the inner perimeter (IP) of section 215b.

Further, the top of each tube 252 for sections 215b-215d has an outer flange 254 that has an outer perimeter larger than the outer perimeter of its respective body 252. The bottom of each tube 252 for sections 215a-215c has an inner flange 257 that engages the outer flange 254 of an adjacent tube 252 as the arm cover 215 is being extended. For example, assume that the arm cover 215 is extended to the position shown by FIG. 14 from the position shown by FIG. 13. In such an example, section 215a moves with the belt retainer 52 as it is pulled from the seat buckle 25. Eventually, the inner flange 257 of section 215a contacts the outer flange 254 of section 215b. As the section 215a continues to move in the y-direction, the section 215b is pulled by the section 215a and also moves in the y-direction. Eventually, the inner flange 257 of section 215b contacts the outer flange 254 of section 215c, and section 215c begins moving in the y-direction. The section 215d is coupled to the base plate 212. Therefore, when the inner flange 257 of section 215c contacts the outer flange 254 of section 215d, the section 215d is prevented from moving in the y-direction. Thus, the outer flange 254 of the section 215d serves as a stop for preventing further extension of the arm cover 215.

Accordingly, the sections 215b-215d all fit within the section 215a while the arm cover 215 is in the collapsed state shown by FIG. 13. As the belt retainer 52 is moved away from the seat buckle 25, the sections 215b-215c are exposed one-by-one until the fully extended state shown by FIG. 14 is eventually reached. Note that is unnecessary for the belt retainer 52 to be moved all of the way to the position shown by FIG. 14. In this regard, at any point during the extension of the arm cover 215, the release actuator 231 can be released thereby locking the belt retainer 52 in a fixed position relative to the seat buckle 25, as will be described in more detail hereafter. In such an example, the arm cover 215 is left in a partially extended position. As an example, the belt retainer 52 may be positioned such that sections 215b, 215c are exposed, but the section 215d may be within and hidden by section 215c.

As the belt retainer 52 is moved toward the seat buckle 25, the arm cover 215 collapses to the position shown by FIG. 13. In this regard, as the belt retainer 52 is moved toward the seat buckle 25 from the fully extended position shown by FIG. 14, the section 215c due to gravity slides over the section 215d. Similarly, the section 215b slides over the section 215c, and the section 215a slides over section 215b. Thus, when the collapsed state of FIG. 13 is reached. The sections 215b-215d are hidden within the section 215a.

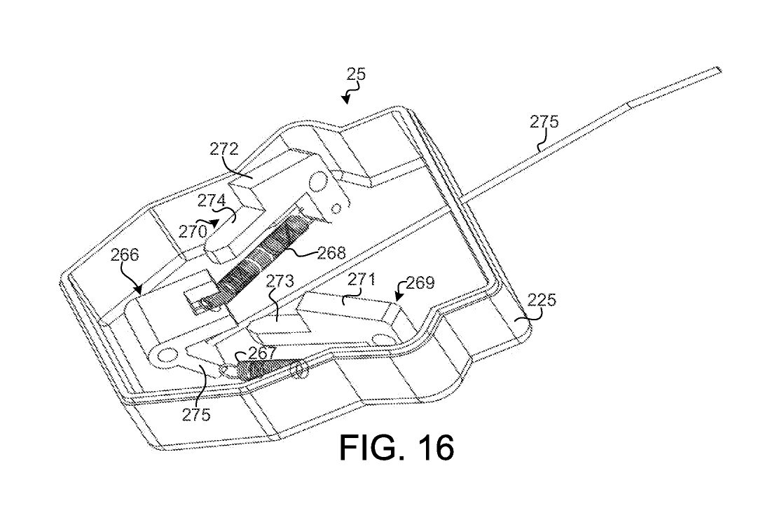

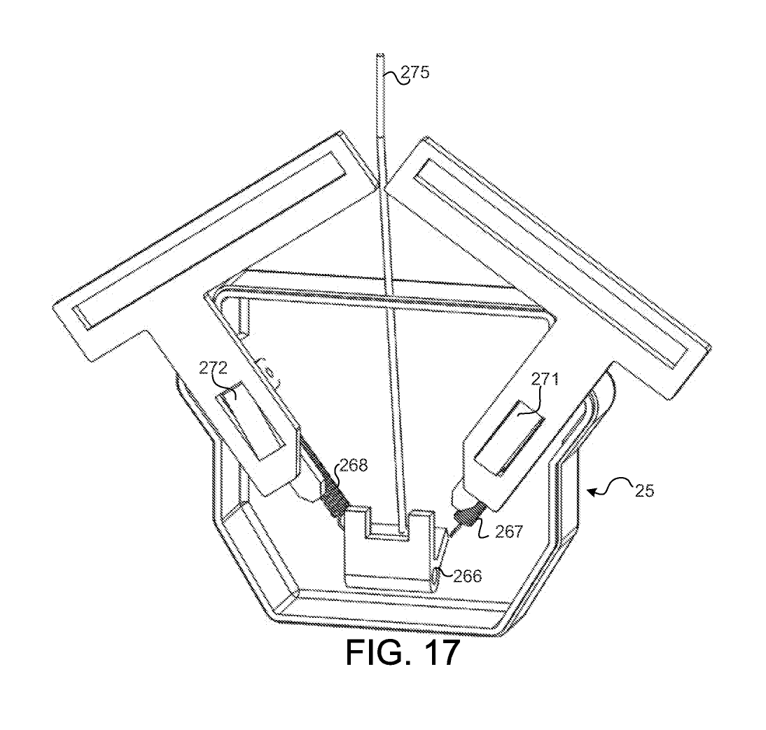

Referring to FIG. 14, the seat buckle 25 has a front cover 221 and a back cover 225. FIG. 16 depicts the seat buckle 25 with the front cover 225 and the button 42 removed in order to expose components 266-272 normally hidden from view. As shown by FIG. 16, the seat buckle 25 has a pivoting member 266 that resides underneath and contacts the button 42. In addition, a pair of springs 267, 268 is coupled to a pair of buckling members 269, 270, respectively. Each buckling member 269, 270 has a respective head 271, 272 and a respective arm 273, 274. The arm 273 extends from the head 271, and the arm 274 extends from the head 272. The head 271 of the member 269 passes through the hole 246 of the buckle tongue 36 to secure the buckle tongue 36 to the seat buckle 25, and the head 272 of the member 270 passes through the hole 257 of the buckle tongue 37 to secure the buckle tongue 37 to the seat buckle 25, as shown by FIG. 17.

When the button 42 is pressed by a user, the button 42 pushes on the arms 273, 274 to generate a force that rotates the buckling members 269, 270. Such rotation causes the buckling member 269 to slip out of the hole 246 and the buckling member 270 to slip out of the hole 247 thereby releasing the buckle tongues 36, 37 from the seat buckle 25. In addition, the rotation of the buckling members 269, 270 load the springs 268, 269 such that the forces generated by the springs 268, 269 return the buckling members 269, 270 to their original positions when the button 42 is released by the user.

As shown by FIG. 16, a cable 275 is coupled to the pivoting member 266. In one exemplary embodiment, the cable 275 is composed of steel, but other materials are possible in other embodiments. As will be described in more detail hereafter, the cable 275 is also coupled to the belt retainer 52. Further, the cable 275 runs through and is hidden by the arm cover 215 (FIG. 14).

A base 275 of the pivoting member 266 is pivotally coupled to the back cover 225, and the springs 267, 268 are each coupled to the base 275. When the button 42 is pressed by a user, the button 42 presses against the pivoting member 266 causing it to rotate. The rotating of the pivoting member 266 that occurs when the button 42 (not shown in FIG. 16) is pressed pulls the cable 275 in a direction away from the belt retainer 52. Such action releases the belt retainer 52 such that it no longer couples the shoulder belts 26, 27 to one another. Thus, activation of the button 42 not only releases the buckle tongues 36, 37 from the seat buckle 25 but also releases the belt retainer 52, as will be described in more detail hereafter. Note that the cord 275 is coupled to a spring loaded pulley (not shown in FIG. 16) of the belt retainer 52, and the spring loaded pulley pulls the pivoting member 266 back to its original position when the button 42 is released by the user.

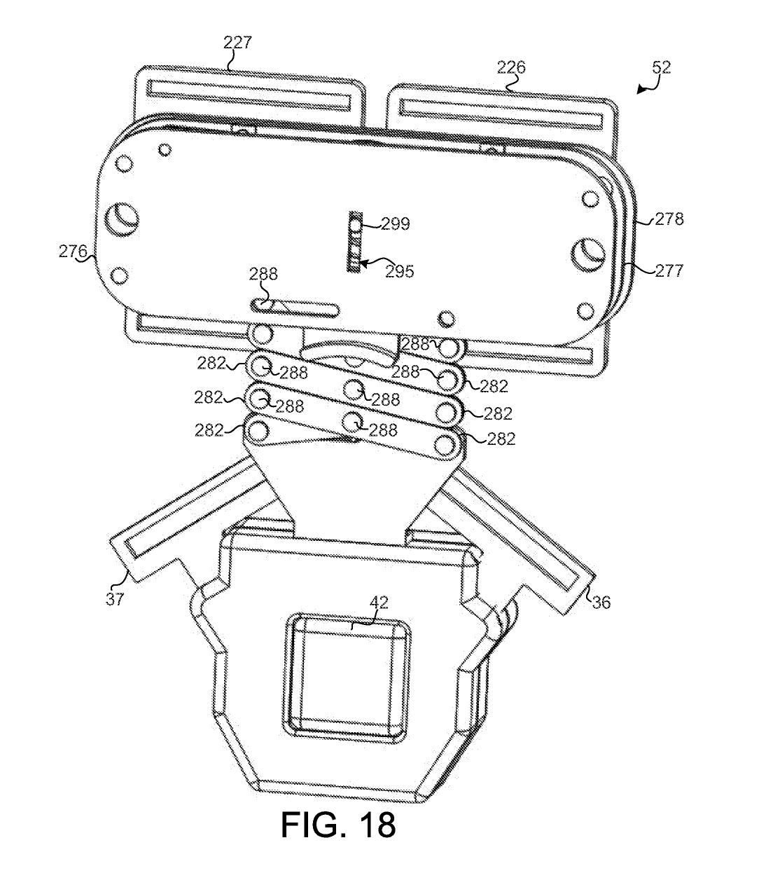

FIG. 18 depicts the embodiment of FIG. 13 with the covers 215, 229 removed for illustrative purposes. As shown by FIG. 18, the belt retainer 52 has a plurality of plates 276-278, which will be described in more detail hereafter. The belt retainer 52 is coupled to the seat buckle 25 by a movable arm 280, which is normally hidden by the arm cover 215. In the embodiment shown by FIG. 18, the movable arm 280 has a plurality of arm segments 282 that are connected to one another via pins 288 and rotate about the pins 288 like scissors. Thus, the exemplary movable arm 280 shown by FIG. 18 shall be referred to hereafter as a “scissor arm.” In other embodiments, other types of arms are possible.

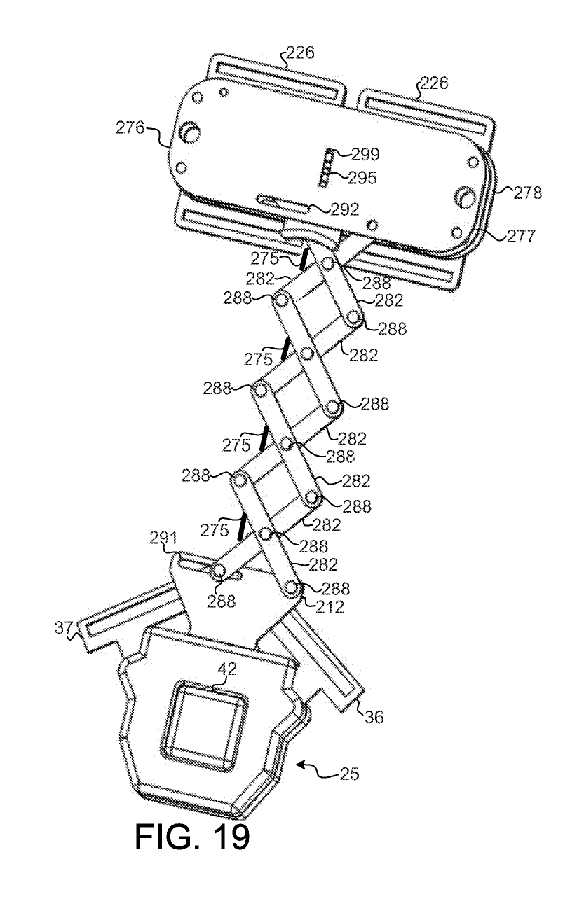

In the exemplary embodiment shown by FIG. 18, each arm segment 282 has at least three pins 288 passing through it. As best illustrated in FIG. 19, for each arm segment 282 (except for the segments 282 coupled directly to the seat buckle 25 or the belt retainer 52), each end of the arm segment 282 is coupled to an end of another arm segment 282 via one of the pins 288. Further, the midpoint of each arm segment 282 is coupled to the midpoint of another arm segment 282 via one of the pins 288. The segment arms 282 pivot about the pins 288 as belt retainer 52 moves. Therefore, the angle of each arm segment 282 relative to another arm segment 282 coupled to it changes as the belt retainer 25 is moved relative to the seat buckle 25 thereby changing the overall length (in the y-direction) of the scissor arm 280. Thus, the arrangement of the arm segments 282 of the scissor arm 280 is similar to that of the arm segments of a conventional scissor jack. Note that the positioning of the pins 288 relative to the segment arms 282 coupled by the pins 288 can be varied. For example, it is unnecessary for a segment arm 282 to have a pin 288 at its midpoint. Such pin 288 can be positioned toward either end of the segment arm 282.

As shown by FIG. 19, the ends of two of the arm segments 282 are coupled to the base plate 212 of the seat buckle 25 via pins 288. The position of the pin 288 coupling one of such arm segments 282 to the base plate 212 is fixed relative to the base plate 212. However, the pin 288 coupling the other such arm segment 282 passes through a slot 291 in the base plate 212 and is capable of sliding along such slot 291 as the belt retainer 52 moves relative to the seat buckle 25.

Similarly, the ends of two of the arm segments are coupled to one of the plates 276 of the belt retainer 52 via pins 288. The position of the pin 288 coupling one of such arm segments 282 to the plate 276 is fixed relative to the plate 276. However, the pin 288 coupling the other such arm segment 282 passes through a slot 292 in the plate 276 and is capable of sliding along such slot 292 as the belt retainer 52 moves relative to the seat buckle 25.

Moreover, when the belt retainer 52 is moved away from the seat buckle 25, the segment arms 282 pivot about their respective pins 288 such that the overall length (in the y-direction) of the scissor arm 280 increases. As the length increases, the width (in the x-direction) of the scissor arm 280 decreases, and the pin 288 passing through the slot 291 moves through the slot 291 in the x-direction to accommodate the decreasing width of the scissor arm 280. In addition, the pin 288 passing through the slot 292 similarly moves through the slot 292 in the x-direction to accommodate the decreasing width of the scissor arm 280.

When the belt retainer 52 is moved toward the seat buckle 25, the segment arms 282 pivot about their respective pins 288 such that the overall length (in the y-direction) of the scissor arm 280 decreases. As the length decreases, the width (in the x-direction) of the scissor arm 280 increases, and the pin 288 passing through the slot 291 moves through the slot 291 to accommodate the increasing width of the scissor arm 280. In addition, the pin 288 passing through the slot 292 similarly moves through the slot 292 to accommodate the increasing width of the scissor arm 280.

As shown by FIGS. 18 and 19, the plate 276 has a slot 295 through which a pin 299 extends. The pin 299 is coupled to a pulley (not shown in FIGS. 18 and 19). The slot 295 helps to guide the pin 299 as it moves relative to the plate 276, as will be described in more detail hereafter.

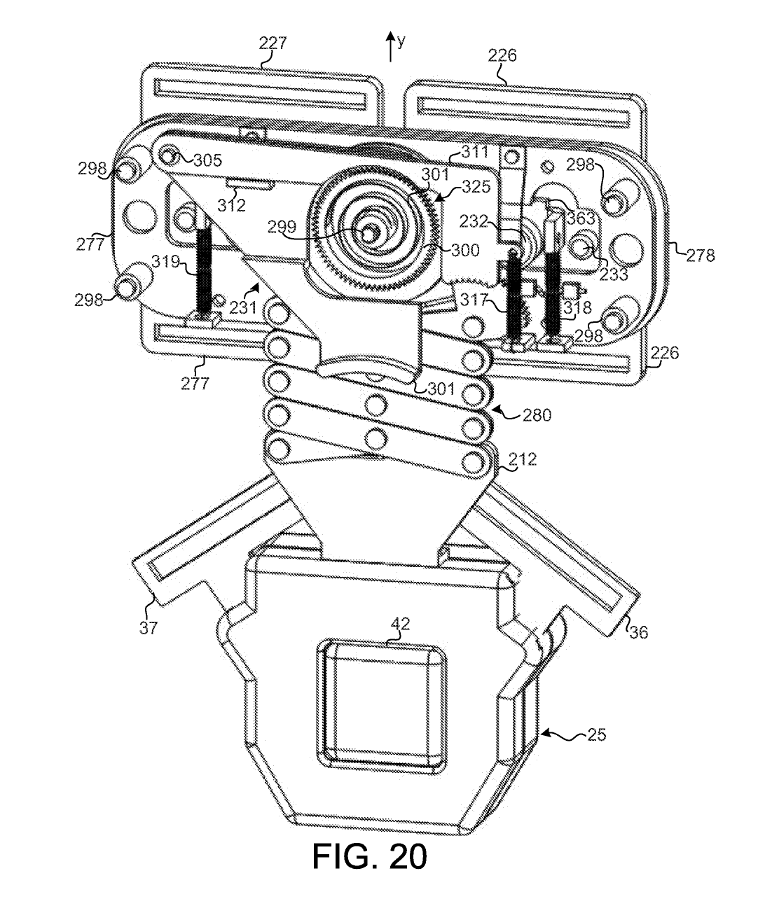

FIG. 20 shows the embodiment of FIG. 18 with the plate 276 removed for illustrative purposes. As shown by FIG. 20, a plurality of pins 298 are mounted on the plate 277 and couple the plate 277 to the plate 276 (FIG. 18). As further shown by FIG. 20, the pin 299 extends through a pulley 300, which rotates about the pin 299. In this regard, the pulley 300 is coupled to the cable 275 (FIG. 16), which extends from the seat buckle 25. In addition, the pulley 300 is spring loaded via a clock spring 301 such that the pulley 300 rotates and draws portions of the cable 275 into the belt retainer 52 when the belt retainer 52 is moved toward the belt buckle 25. In particular, the pulley 300 rotates such that the cable 275 wraps around the pulley 300. When the belt retainer 52 is moved away from the seat buckle 25, the seat buckle 25 holds the cable 275 creating a force that counteracts the force of the spring 301. Thus, the pulley 300 rotates allowing the cable 275 to unwrap from the pulley 300 thereby increasing the cable distance from the pulley 300 to the seat buckle 25. Therefore, the cable 275 extending from the pulley 300 to the seat buckle 25 generally remains taut since any slack is taken up by the spring loaded pulley 300.

The release actuator 231 has a curved end 301 that is accessible to and can be pressed by a user. The release actuator 231 is coupled to the plate 277 via a pin 305 that extends through the release actuator 231 and is mounted on the plate 277. The release actuator 231 has a pulley release element 310 and an arm release element 311. Both of the elements 310, 311 pivot about the pin 305, and the elements 310, 311 can move with respect to each other. As shown by FIG. 20, the pulley release element 310 has a tab 312 that contacts the arm release element 311.

The arm release element 311 engages one of the arm segments 282 of the scissor arm 280. In this regard, the foregoing arm segment 282 has a curved row of teeth 314 (FIG. 21), which engage a curved row of teeth 315 (FIG. 21) of the arm release element 311. The radius of curvature of the teeth 314 is equal to the radius of curvature of the teeth 315, although unequal radii of curvature are possible in other embodiments.

The release actuator 231 is spring loaded via a spring 317 such that the arm release element 311 presses against the arm segment 282 that is engaged with the teeth 315. In such a configuration, the arm release element 311 prevents the arm segment 282 that is engaged with the teeth 315 from rotating about its pin 288. Since one of the arm segments 282 is prevented from rotating about one of its pins 288, all of the arm segments 282 are prevented from rotating about their respective pins 288 thereby locking the scissor arm 280 such that the belt retainer 52 is prevented from moving toward or away from the seat buckle 25 along the y-direction. For illustrative purposes, FIG. 21 depicts the embodiment of FIG. 20 with the clock spring 301, the spring 317, and a pair of springs 318, 319 removed for illustrative purposes. The springs 318, 319 will be described in more detail hereafter.

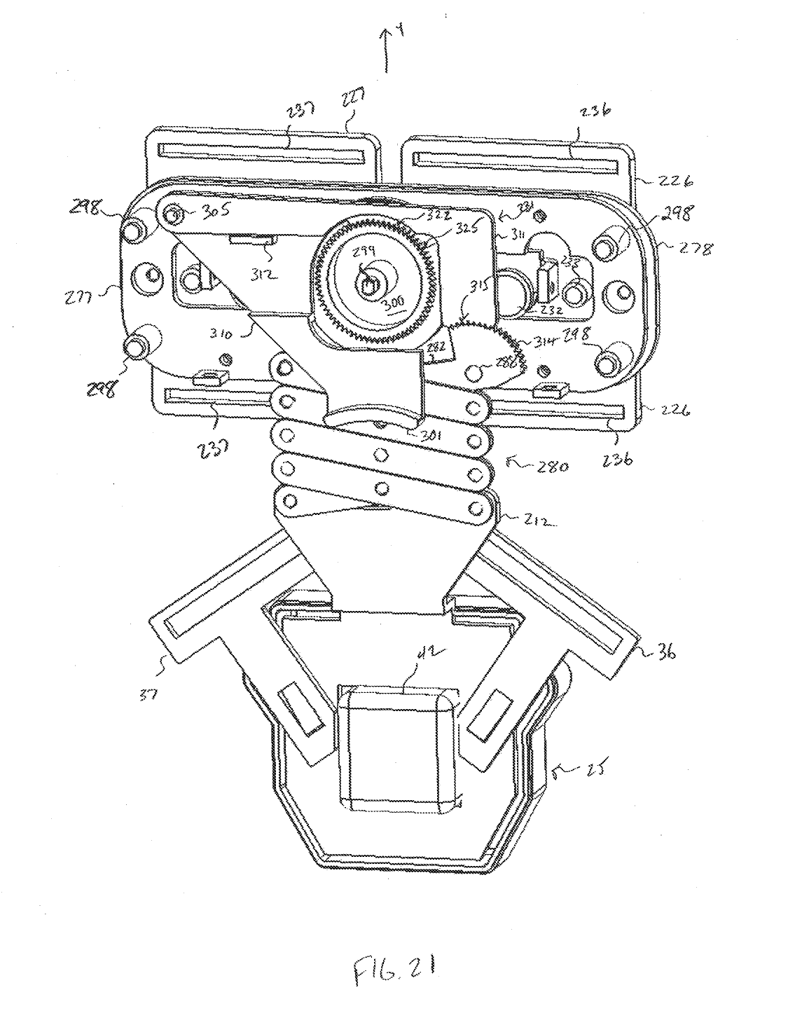

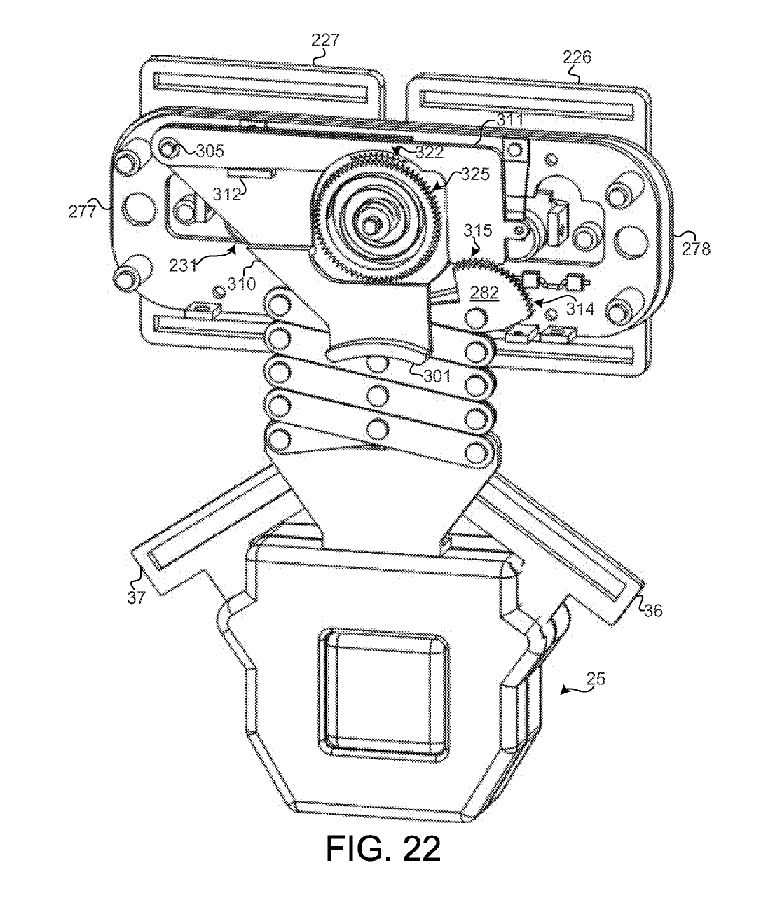

Moreover, to enable movement of the belt retainer 52 relative to the seat buckle 25, a user activates the release actuator 231 by pressing the end 301 in the y-direction causing the pulley release element 310 to rotate about the pin 305. Such action causes the tab 312 to push against the arm release element 311 thereby rotating the element 311 about the pin 305 as well. The rotation of the arm release element 311 generates a force that counteracts the force of the spring 317 and causes the arm release element 311 to separate from the arm segment teeth 314, as shown by FIG. 22. When this occurs, the arm segments 282 are released by the arm release element 311 such that they can pivot about their respective pins 288. Therefore, the belt retainer 52 is free to move back and forth along the y-direction. Once the user releases the release actuator 231, the spring 317 causes the release actuator 231 to rotate about the pin 305 in the opposite direction until the teeth 315 of the arm release element 311 engage the teeth 314 of the arm segment 282 again locking the scissor arm 280 such that the belt retainer 52 is prevented from moving relative to the seat buckle 25 along the y-direction.

Accordingly, to position the belt retainer 52 along the shoulder belts 26, 27, a user moves the belt clips 226, 227 along the shoulder belts 26, 27 to a desired position. The user presses the end 301 of the release actuator 231 such that the teeth 315 of the arm release element 311 disengage the arm segment teeth 314. The user then moves the belt retainer 52 to the belt clips 226, 227 and detachably couples the belt clips 226, 227 to the belt retainer 52.

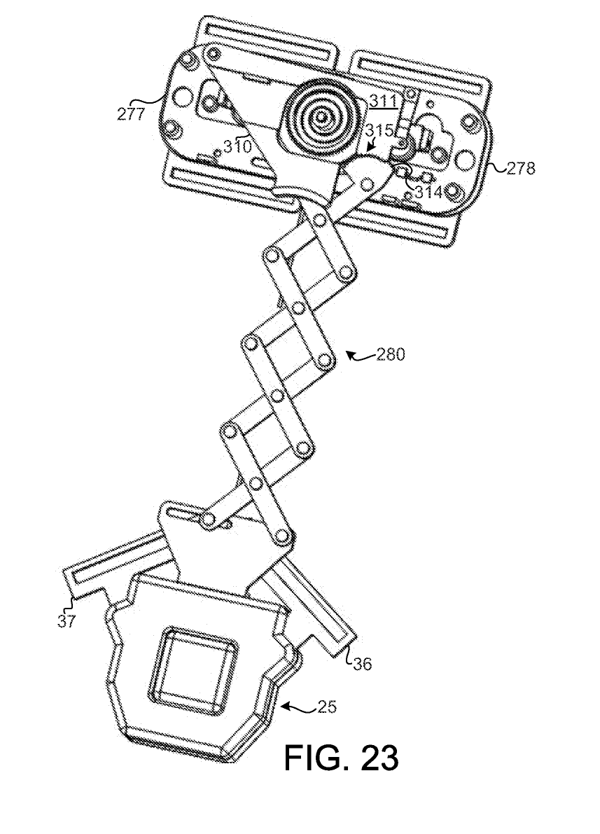

If the belt retainer 52 is moved away from the seat buckle 25, the arm segments 282 pivot about their respective pins 288 such that the overall length of the scissor arm 280 increases and the pulley 300 rotates such that the length of the cable 275 from the seat buckle 25 to the pulley 300 increases. FIG. 23 shows the embodiment of FIG. 21 after the belt retainer 52 has been moved away from the seat buckle 25. If the belt retainer 52 is moved toward the seat buckle 25, the arm segments 282 pivot about their respective pins 288 such that the overall length of the scissor arm 280 decreases and the pulley 300 rotates such that the length of the cable 275 from the seat buckle 25 to the pulley 300 decreases. When the desired belt retainer position relative to the seat buckle 25 is reached, the user releases the end 301 of the release actuator 231 causing the teeth 315 of the arm release element 311 to engage the arm segment teeth 314. At this point, the position of the belt retainer 52 is locked such that the belt retainer 52 can no longer move along the y-direction toward or away from the seat buckle 25.

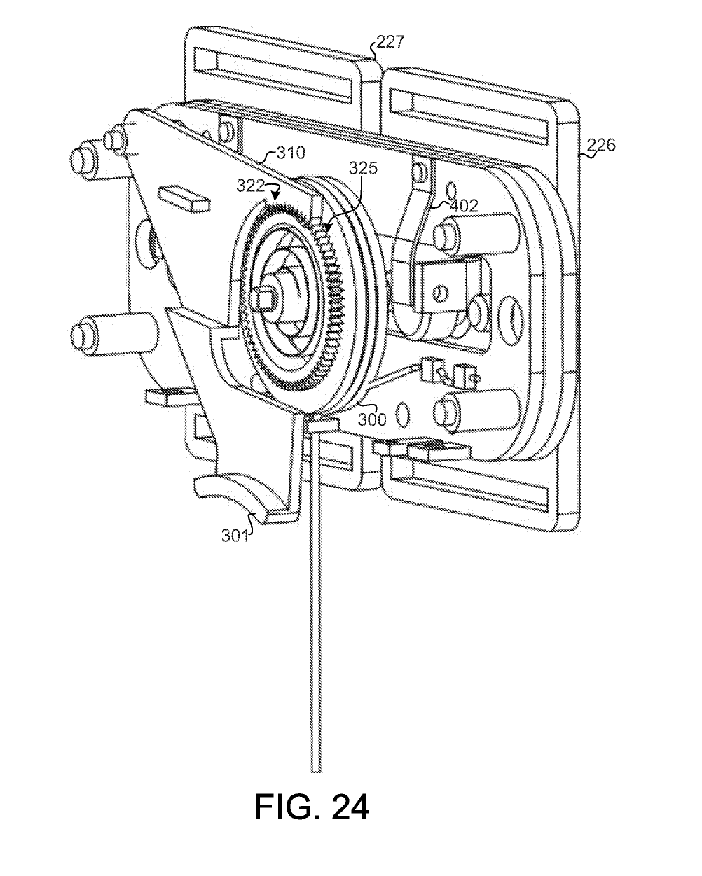

As shown by FIGS. 21 and 24, the pulley release element 310 also has a row of teeth 322 that engage a row of teeth 325 of the pulley 300 when the element 310 is not being pushed by a user. In this regard, a spring (not shown) generates a force that presses the pulley release element 310 against the pulley 300. When the teeth 322, 325 are engaged, the pulley 300 is prevented from rotating about the pin 299.

When the user is pressing against the end 301 such that the release actuator 231 pivots about the pin 305, the teeth 322 of the pulley release element 310 separate from the teeth 325 of the pulley 300, as shown by FIG. 22. Thus, the pulley 300 is free to rotate. Accordingly, when a user activates the release actuator 231 by pressing the end 301 such that the release actuator 231 pivots about the pin 305, both the scissor arm 280 and the pulley 300 are released. As described above, the user can move the belt retainer 52 toward or away from the seat buckle 25 while the release actuator 231 is activated. During such sliding, the pulley 300 rotates to either provide or take up slack depending on the direction of movement. Once the user releases the end 301, the teeth 322 of the pulley release element 310 engage the teeth 325 of the pulley 300, and the teeth 315 of the arm release element 311 engages the arm segment teeth 314 thereby locking both the scissor arm 280 and the pulley 300.

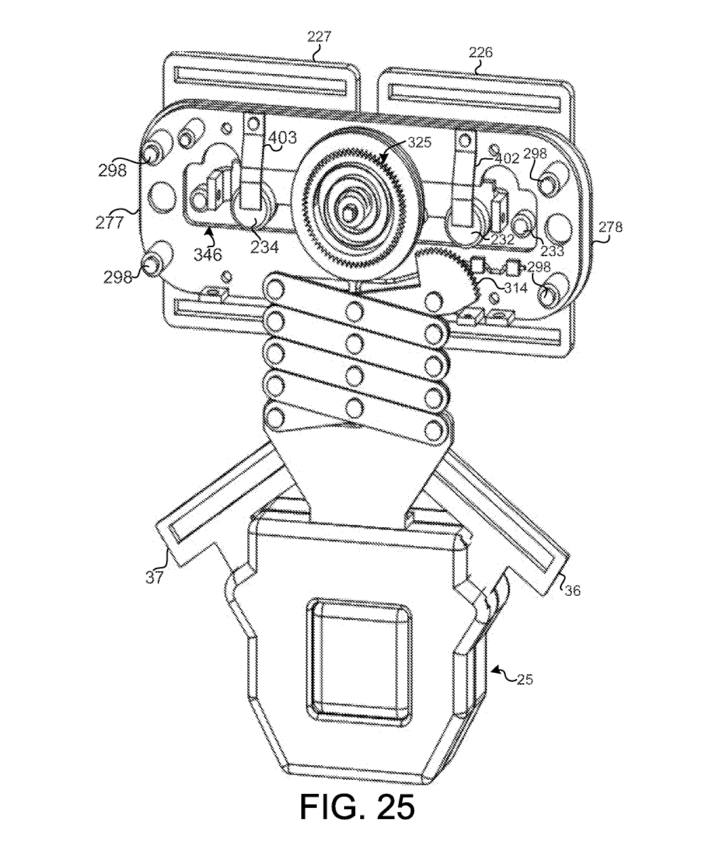

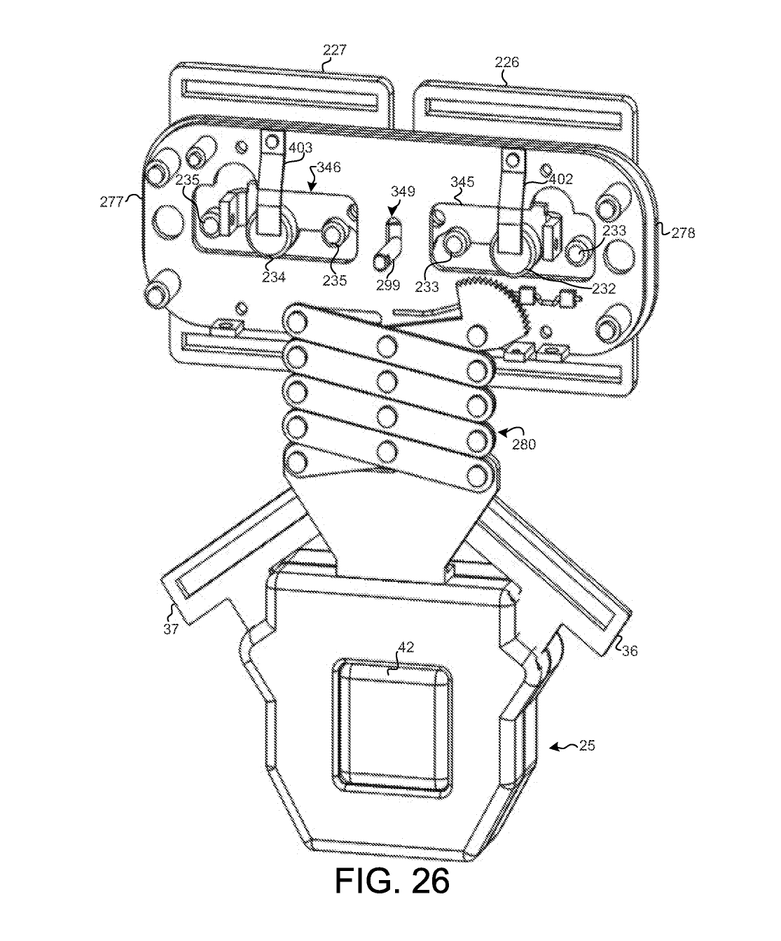

FIG. 25 shows the embodiment of FIG. 21 with the release actuator 231 removed for illustrative purposes. As shown by FIG. 25, the plate 277 has holes 345, 346 through which the pegs 232, 234 of the clips 226, 227 extend, respectively. FIG. 26 shows the embodiment of FIG. 25 with the pulley 300 removed for illustrative purposes. As shown by FIG. 26, the plate 277 also has a slot 349, which helps to guide the pin 299 when such pin 299 moves, as will be described in more detail hereafter.

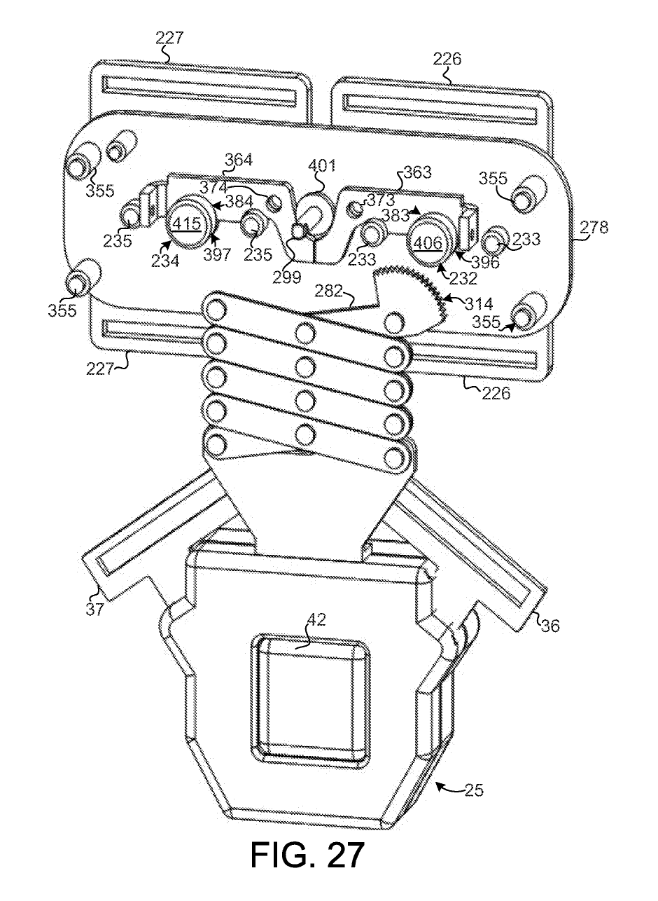

FIG. 27 depicts the embodiment of FIG. 25 with the plate 277 removed for illustrative purposes. As shown by FIG. 26, a plurality of pins 355 are mounted on the plate 278 and couple the plate 278 to the plate 277 (FIG. 26). As further shown by FIG. 27, a pair of levers 363, 364 is coupled to the plate 278 via pins 373, 374, respectively. The lever 363 rotates about the pin 373, and the lever 364 rotates about the pin 374. Further, the lever 363 has a notch 383 for receiving the peg 232, and the lever 364 has a notch 384 for receiving the peg 234.

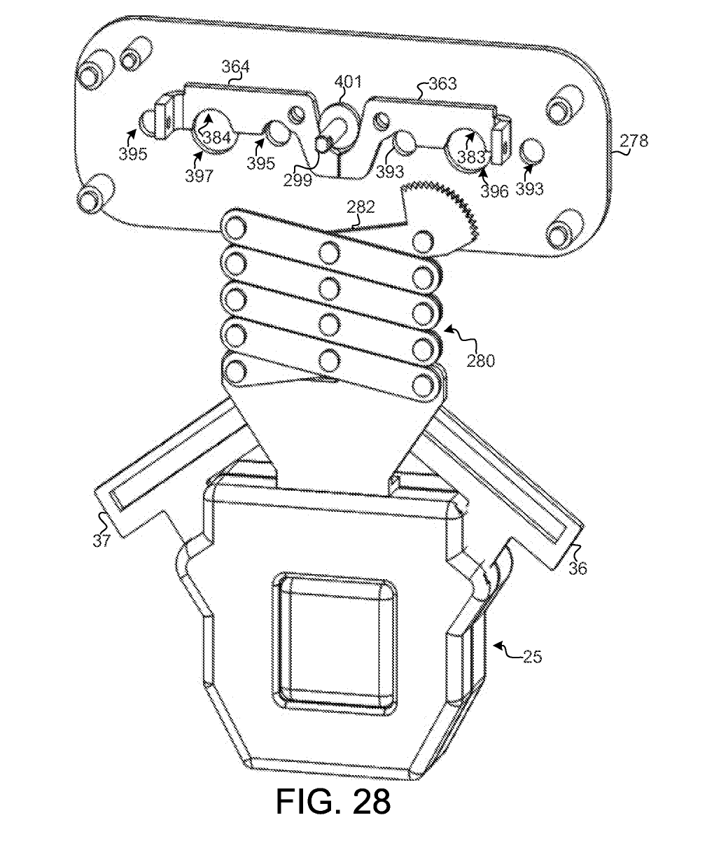

The plate 278 has a pair of holes 393 for receiving the alignment pins 233 and a pair of holes 395 for receiving the alignment pins 235, as shown by FIG. 28. The plate 278 also has a hole 396 for receiving the peg 232 and a hole 397 for receiving the peg 235.

The pin 299 has a head 401, which is not mounted on or otherwise coupled to the plate 278. Thus, the pin 299 is movable with respect to the plate 278. The diameter of the head 401 is larger than the width of the slot 349 (FIG. 26) in the plate 377 in order to help prevent the pin 299 from slipping out of the slot 349.

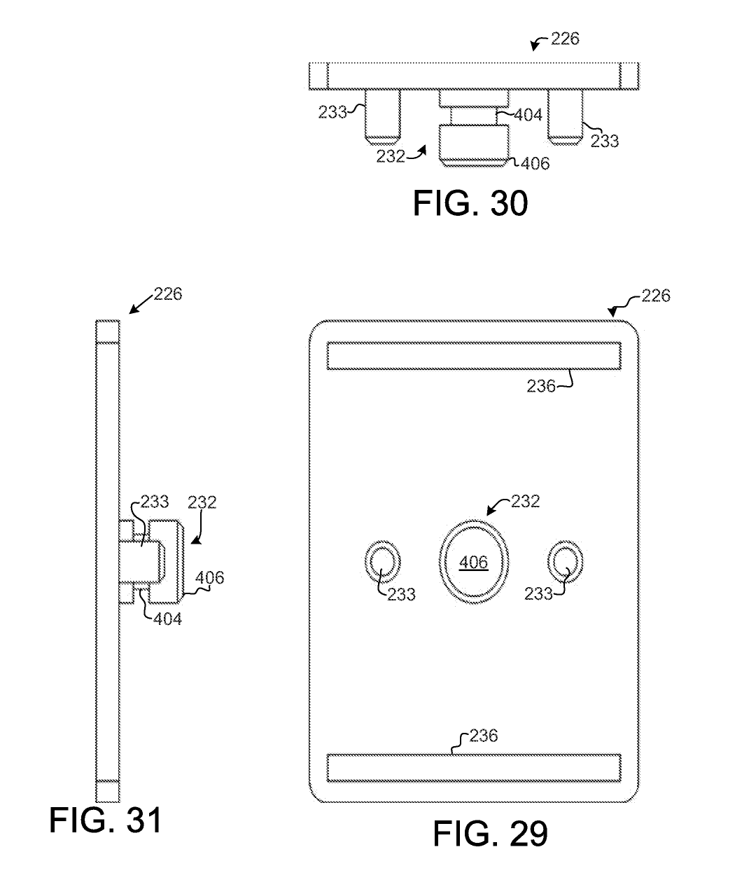

As shown by FIGS. 29-31, each of the pegs 232, 234 is tapered. In this regard, the peg 232 has a body 404 and a head 406. The perimeter of the head 406 is greater than the perimeter of the body 404. Similarly, the peg 234 has a body (not shown) and a head 415 (FIG. 27), and the perimeter of the head 415 is greater than the perimeter of the body. In one exemplary embodiment, the belt clip 227 and, therefore, the head 415 are configured identical to the belt clip 226 and the head 406, respectively.

Further, the radius of curvature of the notch 383 is approximately equal to the radius of curvature of the body 404 such that the body 404 is flush with the notch 383 when the lever 363 is positioned as shown by FIG. 27. In such a position, a portion of the lever 363 is between the head 406 and the plate 278 thereby securing the belt clip 226 to the plate 278 and, therefore, the belt retainer 52.

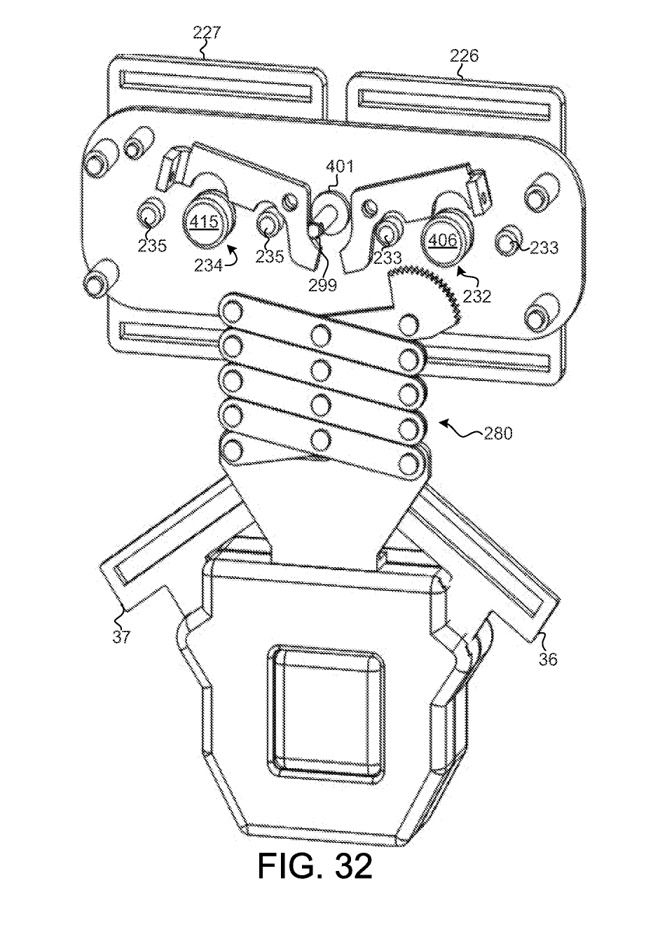

In addition, the lever 363 is spring loaded via the spring 318 (FIG. 20) such that it is pressed against the body 404 of the peg 232. To detachably couple the belt clip 226 to the belt retainer 52, the peg 232 is inserted through the hole 396 in the plate 278 such that the head 406 of the peg 232 contacts the lever 363. As the belt clip 226 and the belt retainer 52 are pushed together, the force exerted by the head 406 pushes the lever 363 such that the lever 363 pivots about the pin 373 thereby counteracting the force of the spring 318 (FIG. 20), as shown by FIG. 32. Once the head 406 passes the lever 363, the force of the spring 318 rotates the lever 363 about the pin 373 such that the lever 363 contacts the body 404 of the peg 232 thereby moving the lever 363 into the position shown by FIG. 27. At this point, the belt clip 226 is secured to the belt retainer 52.

Similarly, the radius of curvature of the notch 384 is approximately equal to the radius of curvature of the body (not shown) of the peg 234 such that the body is flush with the notch 384 when the lever 364 is positioned as shown by FIG. 27. In such a position, a portion of the lever 364 is between the head 415 and the plate 278 thereby securing the belt clip 227 to the plate 278 and, therefore, the belt retainer 52.

In addition, the lever 364 is spring loaded via a spring 319 (FIG. 20) such that it is pressed against the body of the peg 234. The belt clip 227 can be detachably coupled to the belt retainer 52 in the same way the belt clip 226 is described above as being detachably coupled to the belt retainer 52.

As described above, the belt clips 226, 227 are released from the belt retainer 52 when a user presses the button 42 of the seat buckle 25. In this regard, when the button 42 is pressed, the pivoting member 266 (FIG. 16) rotates pulling the cord 275 in a direction away from the belt retainer 52. When releasing the belt clips 226, 227 from the belt retainer 52, the release actuator 231 is not activated such that the pulley 300 (FIG. 21) and the scissor arm 280 are locked. Therefore, the pulley 300 is unable to rotate as the cord 275 is pulled by the pivoting member 266. Accordingly, the force generated by the pull of the cord 275 does not rotate the pulley 300 but rather pulls the pulley 300 toward the seat buckle 25 along the y-direction. Thus, the pin 299 moves through the slot 349 (FIG. 26) toward the seat buckle 25. Note that as the pulley 300 is moved downward by the force from the cord 275, the pulley release element 310, which is spring loaded, moves with the pulley 300 such that the teeth 322, 325 remained engaged. In this regard, since the release actuator 231 is not activated by the user, the pulley release element 310 is pushed against the pulley 300 as the pulley 300 moves. The arm release element 311, however, remains stationary so that the pulley release element 310 moves with respect to the arm release element 311.

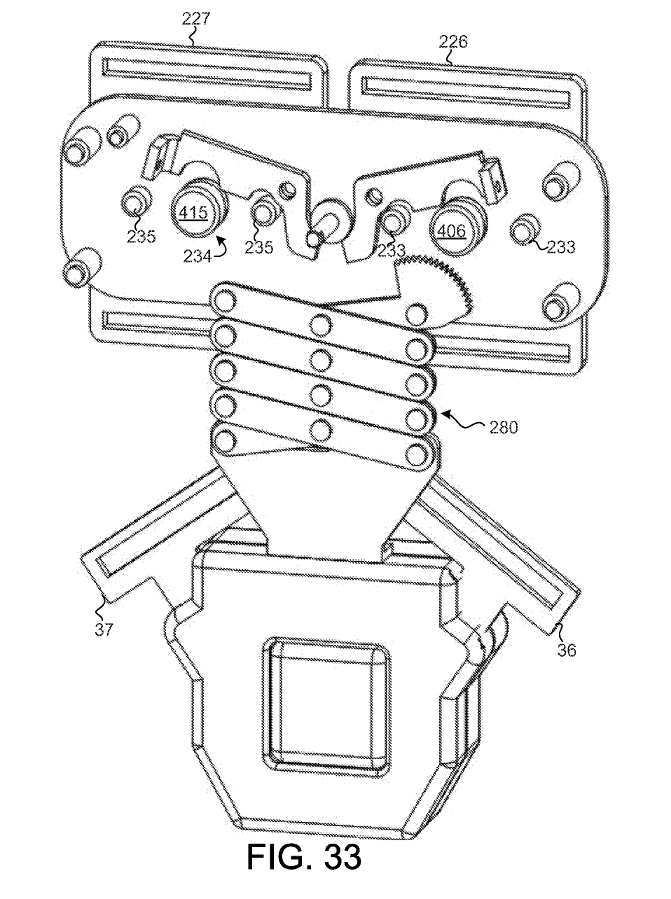

Referring to FIG. 27, such movement of the pin 299 through the slot 349 causes the pin's head 401 to press against the levers 363, 364 rotating the levers about the pins 373, 374, respectively, as shown by FIG. 33. When the levers 363, 364 are rotated, as shown by FIG. 33, the levers 363, 364 are no longer between the heads 406, 415 of the pegs 232, 234, respectively, and the belt clips 226, 227 are, therefore, no longer secured to the belt retainer 52. Gravity causes the belt retainer 52 to separate from the belt clips 226, 227 and fall away from such clips 226, 227. In one exemplary embodiment, release springs 402, 403 (FIG. 26), which are respectively loaded when the pegs 232, 234 are inserted through the plate 278, push against the pegs 232, 234. When the levers 363, 364 are rotated, as shown by FIG. 33, the springs 402, 403 help to separate the belt retainer 52 from the clips 226, 227. In any event, regardless of whether release springs are used, a single release action (e.g., activating the button 42) releases the buckle tongues 36, 37 from the seat buckle 25 and also releases the belt retainer 52 from the clips 226, 227.

In at least one embodiment, a safety seat 15 has a release actuator 64 for releasing the shoulder belts 26, 27 from anchors 106, 107 and a release actuator 41 for releasing the buckle tongues 36, 37 and the belt retainer 52. Therefore, a user may enable a child to be removed from the safety seat 15 by activating either release actuators 41 or 64.

Now, therefore, the following is claimed:

1. A child safety seat having an emergency release harness system, comprising:
a base having a first aperture and a second aperture;
a first belt passing through a first buckle tongue and the first aperture;
a second belt passing through a second buckle tongue and the second aperture;
a buckle for buckling the first and second buckle tongues;
a first anchor secured to the first belt;
a second anchor secured to the second belt; and
an emergency release actuator that is positioned such that the emergency release actuator is accessible when the child safety seat is secured to a vehicle seat, wherein activation of the emergency release actuator by a user releases the first belt from the first anchor and releases the second belt from the second anchor.

2. The child safety seat of claim 1, wherein the first anchor passes through a loop of the first belt when the first anchor is secured to the first belt, wherein the second anchor passes through the loop of the second belt when the second anchor is secured to the second belt.

3. The child safety seat of claim 2, further comprising:
a first cable coupled to the emergency release actuator and the first anchor; and
a second cable coupled to the emergency release actuator and the second anchor.

4. The child safety seat of claim 3, wherein movement of the emergency release actuator from a first position to a second position causes the first cable to pull the first anchor from the loop of the first belt thereby releasing the first belt from the first anchor, and wherein the movement of the emergency release actuator from the first position to the second position causes the second cable to pull the second anchor from the loop of the second belt thereby releasing the second belt from the second anchor.

5. The child safety seat of claim 4, further comprising a first sleeve and a second sleeve, wherein the first cable passes through the first flexible sleeve, and wherein the second cable passes through the second sleeve.

6. The child safety seat of claim 5, wherein the first and second sleeves are flexible.

7. The child safety seat of claim 5, further comprising:
a first stop; and
a second stop,
wherein the first cable is configured to push the first anchor against the first stop when the emergency release actuator is in the first position, and wherein the second cable is configured to push the second anchor against the second stop when the emergency release actuator is in the first position.

8. The child safety seat of claim 7, further comprising:
a first holding member having a hole through which the first anchor passes when the first anchor is secured to the first belt; and
a second holding member having a hole through which the second anchor passes when the second anchor is secured to the second belt,
wherein the movement of the emergency release actuator from the first position to the second position causes the first cable to pull the first anchor through the hole of the first holding member, and wherein the movement of the emergency release actuator from the first position to the second position causes the second cable to pull the second anchor through the hold of the second holding member.

9. The child safety seat of claim 1, further comprising a belt retainer for retaining the first belt and the second belt, wherein the activation of the emergency release actuator enables a child to be removed from the child safety seat when the first and second buckle tongues are buckled to the buckle and the first and second belts are retained by the belt retainer.

10. An emergency release harness system for a child safety seat, comprising:
at least one belt for securing a child to the child safety seat, the belt having a loop;
at least one anchor secured to the child safety seat, the anchor passing through the loop thereby securing the belt to the anchor;
an emergency release actuator positioned such that the emergency release actuator is accessible when the child safety seat is secured to a vehicle seat; and
a cable coupled to the emergency release actuator and the anchor,
wherein movement of the emergency release actuator causes the cable to pull the anchor from the loop thereby releasing the belt from the anchor.

11. The system of claim 10, further comprising at least one stop, wherein the cable pushes the anchor against the stop when the belt is secured to the anchor.

12. The system of claim 10, further comprising at least one sleeve, wherein the cable passes through the sleeve.

13. A method, comprising the steps of:
securing a child safety seat to a vehicle seat;
securing a child to the child safety seat via a first shoulder belt, a second shoulder belt, and a crotch belt, the crotch belt secured to a buckle, wherein the securing the child to the safety seat step comprises the steps of securing the first shoulder belt to the buckle and securing the second shoulder belt to the buckle, wherein the first shoulder belt is secured to a first anchor of the child safety seat, and wherein the second shoulder belt is secured to a second anchor of the child safety seat;
removing the child from the child safety seat, the removing step comprising the steps of:
releasing the first shoulder belt from the first anchor;
releasing the second shoulder belt from the second anchor; and
pulling the child from the child safety seat after the releasing steps.

14. A child safety seat, comprising:
a base;
a first shoulder belt secured to the base;
a second shoulder belt secured to the base; and
a release actuator accessible to a user when the child safety seat is secured to a vehicle seat, the release actuator configured to release the first and second shoulder belts from the base.

15. The child safety seat of claim 14, further comprising:
a crotch belt secured to the base;
a seat buckle secured to the crotch belt;
a first buckle tongue, the first shoulder belt passing through the first buckle tongue; and
a second buckle tongue, the second shoulder belt passing through the second buckle tongue.

16. A child safety seat, comprising:
a base;
a first belt secured to the base;
a second belt secured to the base;
a seat buckle;
a belt retainer for coupling the first belt to the second belt; and
a first release actuator configured to release the seat buckle and the belt retainer.

17. The child safety seat of claim 16, further comprising:
a first buckle tongue for securing the first belt to the seat buckle, the first belt passing through the first buckle tongue; and
a second buckle tongue for securing the second belt to the seat buckle, the second belt passing through the second buckle tongue.

18. The child safety seat of claim 16, further comprising a belt clip for detachably coupling the first belt to the belt retainer, the first belt passing through the belt clip, wherein activation of the first release actuator releases the belt retainer from the belt clip.

19. The child safety seat of claim 16, further comprising a movable arm coupled to the belt retainer and the seat buckle.

20. The child safety seat of claim 19, wherein the movable arm comprises a scissor arm that increases in length as the belt retainer is moved away from the seat buckle and that decreases in length as the belt retainer is moved toward the seat buckle.

21. The child safety seat of claim 19, further comprising an extendable arm cover, wherein the movable arm is positioned within the arm cover, wherein the arm cover extends to increase a length of the arm cover when the belt retainer is moved away from the seat buckle, and wherein the arm cover collapses to decrease the length when the belt retainer is moved toward the seat buckle.

22. The child safety seat of claim 16, further comprising a cord coupled to the first release actuator and the belt retainer.

23. The child safety seat of claim 22, wherein activation of the first release actuator moves the cord for releasing the first belt from the belt retainer.

24. The child safety seat of claim 22, wherein the belt retainer has a lever configured to rotate in response to movement of the cord.

25. The child safety seat of claim 24, wherein the belt retainer has a pin, and wherein the pin is configured to push the lever in response to movement of the cord thereby rotating the lever.

26. The child safety seat of claim 25, wherein the pin is coupled to a pulley.

27. The child safety seat of claim 26, wherein the pulley is coupled to the cord.

28. The child safety seat of claim 27, wherein the belt retainer has a second release actuator that has teeth, wherein the pulley has teeth, and wherein the teeth of the second release actuator engage the teeth of the pulley thereby preventing the pulley from rotating.

29. The child safety seat of claim 28, wherein activation of the second release actuator by a user separates the teeth of the pulley from the teeth of the second release actuator thereby enabling the pulley to rotate.

30. A method, comprising the steps of:
positioning a child on a base of a child safety seat;
buckling a first belt and a second belt to a seat buckle of the child safety seat;
coupling the first belt to the second belt via a belt retainer; and
activating a release actuator such that the first and second belts are released from the seat buckle via the activating step and such that the belt retainer is released via the activating step.
